(19) United States
(12) Patent Application Publication
(10) Pub. No.: US 2007/0025657 A1
(43) Pub. Date: Feb. 1, 2007

(54) Optical path conversion element

(75) Inventors: Kazuaki Oya, Minato-ku (JP); Shigeo Kittaka, Minato-ku (JP); Keiji Tsunetomo, Minato-ku (JP)

Correspondence Address: HAMRE, SCHUMANN, MUELLER & LARSON, P.C., P.O. BOX 2902, MINNEAPOLIS, MN, 55402-0902, US

(73) Assignee: Nippon Sheet Glass Company Limited, Minato-ku, Tokyo (JP)

(21) Appl. No.: 10/558,995

(22) PCT Filed: Jun. 4, 2004
(86) PCT No.: PCT/JP04/08160

§ 371 Date: Dec. 1, 2005

(30) Foreign Application Priority Data
Jun. 6, 2003 (JP) 2003-161532

(51) Int. Cl. G02F 1/295

(52) U.S. Cl. 385/4

(57) ABSTRACT

An optical path conversion element includes a photonic crystal exhibiting periodicity of refractive index in one direction and using as an incident end face one of end faces substantially parallel with the periodicity direction of refractive index and an exit end face opposite the incident end face, an incident part for passing an incident light through the incident end face such that a propagation light is generated in the photonic crystal by a band on a Brillouin zone boundary, and a device for changing a photonic band structure of the photonic crystal and/or a device for changing a propagation optical path length that is a distance from the incident end face to the exit end face.

### TECHNICAL FIELD

The present invention relates to an optical path conversion element used for an optical communication system, an optical exchange system, an optical interconnection, or the like, and in particular, to an optical path conversion element using a photonic crystal.

### BACKGROUND ART

In the field of optical communication system, an optical exchange system, an optical interconnection, and the like, in order to allow signal light to propagate in a desired path, an optical element having a function of switching an optical path is required. The most basic means for switching an optical path is to change the direction of light mechanically with a reflecting mirror or the like. Recently, an optical path conversion element has been developed that switches an optical path by changing the angle of a reflecting mirror, using micro electro mechanical systems (MEMS), based on the above basic principle. The angle of a reflecting mirror is changed mechanically, so that the optical path can be switched easily with a large angle, while there arises a problem in stability due to the vibration and shock caused by a mobile part.

As an optical path conversion element without a mobile part, for example, a method for using the dependence of the refractive angle of light at an interface between media having different refractive indexes on the refractive indexes of both the media has been considered. For example, if the optical path conversion element is configured so as to have a prism, and the refractive index of the prism can be changed by some method, the direction of light output from the prism can be changed. A diffraction grating, for example, may be used in place of the prism.

However, even when the refractive index of a medium is changed by various kinds of physical means (for example, the application of an electric field to a medium, the application of a sound wave thereto, the irradiation of light thereto, etc.), the refractive index is changed in most cases to a degree less than 1%. Thus, even if an optical path is converted by changing a refractive index, the change in an angle of the optical path is small, so that it is necessary to decrease sufficiently the spread angle of a light beam whose optical path has been converted, and to prolong the propagation distance of the converted light. Therefore, there is a problem that the miniaturization and the like of the optical path conversion element are impossible.

Furthermore, recently, an optical path conversion element using specific properties of a photonic crystal has been proposed. The photonic crystal has a structure in which dielectrics having different refractive indexes are arranged periodically with a period on the order of wavelength of light. It is well known that this photonic crystal has characteristic properties such as “confinement of light by a photonic bandgap”, “very large wavelength dispersion by a specific band structure”, “group velocity abnormality of propagation light”, and the like, and a number of optical elements using such characteristics have been proposed or studied (for example, JP 2002-267845 A).

An optical path conversion element (light beam deflector) using a photonic crystal is disclosed by, for example, JP 2002-350908 A. This optical path conversion element is designed so that the wavelength of propagation light is different from a photonic bandgap wavelength, and a photonic band structure is changed with external energy, whereby the traveling direction of light in the photonic crystal is changed. The propagation light that propagates in the photonic crystal propagates in a direction of a potential gradient of a photonic dispersion surface by the photonic band structure. Thus, in the conventional optical path conversion element, the photonic band structure is changed with external energy, whereby the traveling direction of propagation light is changed.

However, in the conventional optical path conversion element using the photonic crystal, the confinement of light in the direction perpendicular to the traveling direction of light is insufficient. Therefore, the amount of light output from the photonic crystal after having its optical path converted is small. That is, there is a problem that recovery efficiency is very low, and the like. Furthermore, the change in an angle of an optical path is not particularly large. Therefore, a photonic crystal with a size of hundreds of microns or more is required. This causes a problem of presenting an obstacle to the miniaturization and integration.

### DISCLOSURE OF INVENTION

The present invention has been achieved so as to solve the above-mentioned problems, and its object is to provide an optical path conversion element capable of being miniaturized, using a photonic crystal.

An optical path conversion element of the present invention includes: a photonic crystal exhibiting periodicity of refractive index in one direction and using as an incident end face one of end faces substantially parallel with the periodicity direction of refractive index and an exit end face opposite the incident end face; an incident part for passing an incident light through the incident end face such that a propagation light is generated in the photonic crystal by a band on a Brillouin zone boundary; and a device for changing a photonic band structure of the photonic crystal and/or a device for changing a propagation optical path length that is a distance from the incident end face to the exit end face.

### BRIEF DESCRIPTION OF DRAWINGS

FIG. 1 is a cross-sectional view showing the propagation of light in a photonic crystal exhibiting periodicity of refractive index in one direction.

FIG. 2 is a band diagram of the photonic crystal shown in FIG. 1, which also includes incident light.

FIG. 3 is a band diagram in which the band diagram in FIG. 2 is limited to a Z-direction with respect to a Brillouin zone center.

FIG. 4 is a cross-sectional view showing the propagation of light in a photonic crystal in the case where incident light is incident obliquely upon an incident end face.

FIG. 5 is a band diagram of the photonic crystal shown in FIG. 4, which also includes incident light.

FIG. 6 is a cross-sectional view showing the state where propagation light propagates in a Z-axis direction in the case where incident light is incident obliquely upon an incident end face of a photonic crystal.

FIG. 7 is a band diagram of the photonic crystal shown in FIG. 6, which also includes incident light.

FIG. 8 is a band diagram in which the band diagram in FIG. 7 is limited to a Z-direction with respect to a Brillouin zone boundary.

FIG. 9A is a cross-sectional view schematically showing the propagation shape of a first band.

FIG. 9B shows the amplitude of an electric field when FIG. 9A is seen in a Y-direction.

FIG. 9C is a cross-sectional view schematically showing the propagation shape of a second band.

FIG. 9D shows the amplitude of an electric field when FIG. 9C is seen in the Y-direction.

FIG. 10 is a cross-sectional view schematically showing the propagation shape of propagation light in which the first band and the second band shown in FIGS. 9A and 9C are overlapped with each other.

FIG. 11 is a cross-sectional view showing a method using a diffraction grating that realizes the propagation on a Brillouin zone boundary in a photonic crystal.

FIG. 12 is a cross-sectional view showing a method using a phase grating that realizes the propagation on a Brillouin zone boundary.

FIG. 13 is a cross-sectional view showing the propagation shape in which the propagation light in the first and second bands on a Brillouin zone boundary is propagating in a photonic crystal.

FIG. 14A is a cross-sectional view showing output light in the case where the position of an exit end face is placed at a top or bottom peak position of a wave of the propagation light in the photonic crystal shown in FIG. 13.

FIG. 14B is a cross-sectional view showing output light in the case where the position of the exit end face shown in FIG. 13 is placed at an intermediate position between the bottom peak and the top peak of the wave of the propagation light.

FIG. 14C is a cross-sectional view showing output light in the case where the position of the exit end face shown in FIG. 13 is placed at an intermediate position between the top peak and the bottom peak of the wave of the propagation light.

FIG. 15 is a plan view showing a configuration of an optical path conversion element according to Embodiment 1.

FIG. 16 is a plan view showing a configuration of another optical path conversion element according to Embodiment 1.

FIG. 17 is a schematic view illustrating a method for directly changing the period of a photonic crystal.

FIG. 18A is a plan view showing a configuration of a first optical path conversion element according to Embodiment 2.

FIG. 18B is a perspective view showing a configuration of an optical path conversion part of the first optical path conversion element according to Embodiment 2.

FIG. 18C is a cross-sectional view schematically illustrating a configuration of the first optical path conversion element according to Embodiment 2.

FIG. 19 is a plan view showing a configuration of a second optical path conversion element according to Embodiment 2.

FIG. 20A is a cross-sectional view schematically illustrating a configuration of a third optical path conversion element according to Embodiment 2.

FIG. 20B is a cross-sectional view schematically illustrating a configuration of a fourth optical path conversion element according to Embodiment 2.

FIG. 21A is a cross-sectional view schematically illustrating a configuration of an optical path conversion element according to Embodiment 3.

FIG. 21B is a side view schematically illustrating a configuration of another optical path conversion element according to Embodiment 3.

FIG. 22 is a schematic view illustrating a method for changing a propagation optical path length of a photonic crystal.

FIG. 23A is a cross-sectional view schematically illustrating a configuration of an optical path conversion element according to Embodiment 4.

FIG. 23B is a cross-sectional view schematically illustrating a configuration of another optical path conversion element according to Embodiment 4.

FIG. 23C is a cross-sectional view schematically illustrating a configuration of still another optical path conversion element according to Embodiment 4.

FIG. 24 is a band diagram of a photonic crystal with respect to TE polarized light.

FIG. 25 is an intensity distribution diagram of an electric field showing simulation results in Calculation Example 1.

FIG. 26 is an intensity distribution diagram of an electric field showing simulation results in a first reference example in Calculation Example 1.

FIG. 27 is an intensity distribution diagram of an electric field showing simulation results in a second reference example in Calculation Example 1.

FIG. 28 is a band diagram of a photonic crystal with respect to TE polarized light.

FIG. 29 is an intensity distribution diagram of an electric field showing simulation results in Calculation Example 2.

FIG. 30 is a cross-sectional view showing a configuration of a photonic crystal used in Calculation Example 3.

FIG. 31 is an intensity distribution diagram of an electric field showing simulating results in Calculation Example 3.

FIG. 32 is an intensity distribution diagram of an electric field showing simulation results in Calculation Example 4.

FIG. 33 is an intensity distribution diagram of an electric field showing simulation results in Calculation Example 5.

FIG. 34A is an intensity distribution diagram of an electric field showing simulation results in Calculation Example 6.

FIG. 34B is an intensity distribution diagram of an electric field showing simulation results in Calculation Example 7.

### DESCRIPTION OF THE INVENTION

An optical path conversion element of the present invention includes an incident part for passing an incident light through the incident end face such that a propagation light is generated in the one-dimensional photonic crystal by a band on a Brillouin zone boundary, and a device for changing a photonic band structure of the photonic crystal and/or a device for changing a propagation optical path length that is a distance from the incident end face to the exit end face. Therefore, the optical path of output light can be converted with a sufficiently large angle. Thus, the optical path conversion element can be miniaturized and integrated.

Furthermore, preferably, assuming that a wavelength in vacuum of the incident light is λ₀, a refractive index of a medium that is in contact with the incident end face is n, and a period of the photonic crystal is a, the incident light is incident upon the incident part at an incident angle θ satisfying the following expression with respect to the incident end face:
0.45<n·sinθ·(a/λ₀)<0.55.

According to the above configuration, a photonic band on the Brillouin zone boundary can be used, and first band light and high-order propagation band light on the Brillouin zone boundary can be mixed to propagate in the photonic crystal.

The incident angle θ refers to an angle formed by a line normal to the incident end face and the incident light. Furthermore, the period refers to a thickness (length in a layering direction) of basic constituent elements layered periodically in the photonic crystal. For example, regarding a photonic crystal in which two kinds of media are layered alternately, the period is a sum of the thickness of one layer of these media. Furthermore, the medium that is in contact with the incident end face refers to a medium on the periphery of the incident end face.

Furthermore, preferably, the incident part includes a diffraction grating or a phase grating placed in vicinity of or in contact with the incident end face. According to this configuration, a photonic band on the Brillouin zone boundary can be used, and first band light and high-order propagation band light on the Brillouin zone boundary can be mixed to propagate in the photonic crystal.

Furthermore, preferably, the device for changing the photonic band structure supplies energy to the photonic crystal, thereby changing the refractive index of at least one of materials constituting the photonic crystal and changing the photonic band structure of the photonic crystal. According to this configuration, an optical path conversion element capable of converting an optical path can be provided easily.

Furthermore, preferably, at least one of the materials constituting the photonic crystal is a material having an electro-optic effect, and the device for changing the photonic band structure is an electric field applying part for applying an electric field to the photonic crystal. According to this configuration, the refractive index of at least one of the materials constituting the photonic crystal can be changed reversibly. Thus, an optical path conversion element capable of converting an optical path reversibly can be provided.

Furthermore, preferably, at least one of the materials constituting the photonic crystal is a semiconducting material, and the device for changing the photonic band structure is a current injecting part for injecting a current to the photonic crystal. According to this configuration, the refractive index of at least one of the materials constituting the photonic crystal can be changed reversibly. Thus, an optical path conversion element capable of converting an optical path reversibly can be provided.

Furthermore, preferably, at least one of the materials constituting the photonic crystal is an acousto-optic material, and the device for changing the photonic band structure is an ultrasonic wave applying part for applying an ultrasonic wave to the photonic crystal. According to this configuration, the refractive index of at least one of the materials constituting the photonic crystal can be changed reversibly. Thus, an optical path conversion element capable of converting an optical path reversibly can be provided.

Furthermore, preferably, a part or an entirety of at least one of the materials constituting the photonic crystal is a non-linear optical material, and the device for changing the photonic band structure is a light source for irradiating the photonic crystal with light. According to this configuration, the refractive index of a part or an entirety of at least one of the materials constituting the photonic crystal can be changed reversibly. Thus, an optical path conversion element capable of converting an optical path reversibly can be provided.

Furthermore, preferably, the device for changing the photonic band structure is a period changing device for applying an external force to the photonic crystal to change a period of the photonic crystal, thereby changing the photonic band structure. According to this configuration, an optical path can be converted by changing the period of the photonic crystal, so that an optical path conversion element that is operated with a simple mechanism can be provided.

Furthermore, preferably, the period changing device includes: an external force applying part connected to at least one of end faces perpendicular to the periodicity direction of refractive index of the photonic crystal; and a support housing for fixing a length in the periodicity direction of refractive index of the photonic crystal in the external force applying part and the photonic crystal, wherein a volume of the external force applying part changes to apply the external force to the photonic crystal. According to this configuration, the change in the period of the photonic crystal can be changed easily. Thus, an optical path conversion element capable of converting an optical path easily can be provided.

Furthermore, preferably, the external force applying part is a piezoelectric element. According to this configuration, it is easy to control the change in a period of the photonic crystal. Thus, an optical path conversion element capable of controlling the conversion of an optical path easily can be provided.

Furthermore, preferably, the period changing device includes a pair of electromagnets placed so as to oppose each other in the periodicity direction of refractive index of the photonic crystal with the photonic crystal interposed therebetween, and the external force is applied to the photonic crystal, using an attracting force between the electromagnets. According to this configuration, it is easy to control the change in a period of the photonic crystal. Thus, an optical path conversion element capable of controlling the conversion of an optical path easily can be provided.

Furthermore, preferably, the period changing device includes an electromagnet and a magnetic substance placed so as to oppose each other in the periodicity direction of refractive index of the photonic crystal with the photonic crystal interposed therebetween, and the external force is applied to the photonic crystal, using an attracting force between the electromagnet and the magnetic substance. According to this configuration, it is easy to control the change in a period of the photonic crystal. Thus, an optical path conversion element capable of controlling the conversion of an optical path easily can be provided.

Furthermore, preferably, the period changing device includes a substrate connected to the photonic crystal and a temperature-varying device capable of heating or cooling the substrate, and the external force is applied to the photonic crystal, using expansion or contraction of the substrate heated or cooled by the temperature-varying device. According to this configuration, it is easy to control the change in a period of the photonic crystal. Thus, an optical path conversion element capable of controlling the conversion of an optical path easily can be provided.

Furthermore, preferably, the device for changing the propagation optical path length includes: an external force applying part connected to at least one of the incident end face and the exit end face; and a support housing for fixing a length in the direction of propagation optical path length of the photonic crystal in the external force applying part and the photonic crystal, wherein a volume of the external force applying part changes to apply an external force to the photonic crystal. According to this configuration, the change in the propagation optical path length of the photonic crystal can be changed easily. Thus, an optical path conversion element capable of converting an optical path easily can be provided.

Furthermore, preferably, the external force applying part is a piezoelectric element. According to this configuration, it is easy to control the change in the propagation optical path length of the photonic crystal. Thus, an optical path conversion element capable of controlling the conversion of an optical path easily can be provided.

Furthermore, preferably, the device for changing the propagation optical path length includes a pair of electromagnets placed so as to oppose each other in the direction of propagation optical path length of the photonic crystal with the photonic crystal interposed therebetween, and an external force is applied to the photonic crystal, using an attracting force between the electromagnets. According to this configuration, it is easy to control the change in the propagation optical path length of the photonic crystal. Thus, an optical path conversion element capable of controlling the conversion of an optical path easily can be provided.

Furthermore, preferably, the device for changing the propagation optical path length includes an electromagnet and a magnetic substance placed so as to oppose each other in the direction of propagation optical path length of the photonic crystal with the photonic crystal interposed therebetween, and an external force is applied to the photonic crystal, using an attracting force between the electromagnet and the magnetic substance. According to this configuration, it is easy to control the change in the propagation optical path length of the photonic crystal. Thus, an optical path conversion element capable of controlling the conversion of an optical path easily can be provided.

Furthermore, preferably, the device for changing the propagation optical path length includes a substrate connected to the photonic crystal and a temperature varying device capable of heating or cooling the substrate, and an external force is applied to the photonic crystal, using expansion or contraction of the substrate heated or cooled by the temperature varying device. According to this configuration, it is easy to control the change in a period of the photonic crystal. Thus, an optical path conversion element capable of controlling the conversion of an optical path easily can be provided.

Hereinafter, the present invention will be described specifically by way of embodiments with reference to the drawings. In each figure, components having the same functions are denoted with the same reference numerals, and the description thereof is omitted.

When a plane wave having an appropriate frequency is vertically incident from an end face parallel to a period direction (periodicity direction of refractive index) of a photonic crystal, propagation derived from a photonic band structure at a Brillouin zone center occurs in a direction without a periodic structure, and first band propagation light by a lowest-order band and high-order propagation band light by a high-order propagation band that is not the lowest-order band propagate respectively in the photonic crystal.

The high-order propagation band light has characteristic properties derived from a photonic band structure, such as “very large wavelength dispersion” and “group velocity abnormality”, and can be applied to various optical elements using these properties. In contrast, the first band light does not have the above-mentioned properties, and behaves substantially in a similar manner to that of the propagation in an ordinary homogeneous medium.

However, in the case where the high-order propagation band light propagates in the photonic crystal, the first band light also propagates therein without fail. Therefore, in the case of using the high-order propagation band light, the first band light merely is a loss, which degrades the use efficiency of incident light energy, and decreases an S/N ratio of an element as stray light.

However, the study of the inventors of the present invention clarified that, by using a photonic band on a Brillouin zone boundary, the first band light also has the same characteristic properties as those of the high-order propagation band light.

The first band light and the high-order propagation band light on the Brillouin zone boundary are mixed to propagate in the photonic crystal, whereby a characteristics propagation shape is exhibited, in which the wave shape of electric field of propagation light repeats a top peak and a bottom peak alternately. Depending upon which position of the propagation shapes an exit end face is placed at, the direction of output light output from the exit end face varies greatly. The optical path conversion element according to the present embodiment uses the above-mentioned phenomenon.

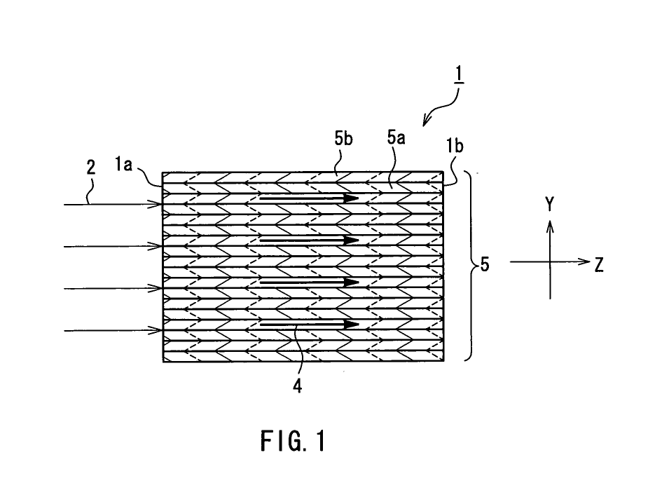

FIG. 1 is a cross-sectional view showing the propagation of light in a photonic crystal 1 exhibiting periodicity of refractive index in one direction. In FIG. 1, it is assumed that the propagation direction of light is a Z-axis direction, and a direction perpendicular to the propagation direction of light is a Y-axis direction. The photonic crystal 1 is a one-dimensional photonic crystal exhibiting periodicity of refractive index only in the Y-axis direction. Materials 5a and 5b are layered alternately in the Y-axis direction to form a multi-layered structure 5. It is assumed that the thickness of the material 5a is t_{A}, and the refractive index thereof is n_{A}. It also is assumed that the thickness of the material 5b is t_{B}, and the refractive index thereof is n_{B}. A period a of the photonic crystal 1 is (t_{A}+t_{B}).

The photonic crystal 1 constitutes an optical waveguide. An incident end face 1a and an exit end face 1b of the photonic crystal 1 are parallel to the period direction of the photonic crystal 1, and the incident end face 1a and the exit end face 1b opposing each other. When a plane wave with a wavelength of λ₀ in vacuum is incident from the incident end face 1a of the photonic crystal 1 as incident light 2, the plane wave propagates in the photonic crystal 1 as propagation light 4. How the propagation light 4 propagates in the multi-layered film of the materials 5a and 5b in the photonic crystal 1 can be known by calculating a photonic band and representing it graphically. A method of band calculation is described in detail, for example, in “Photonic Crystals”, Princeton University Press (1995) or Physical Review Vol. B44, No. 16, p. 8565, 1991, and the like.

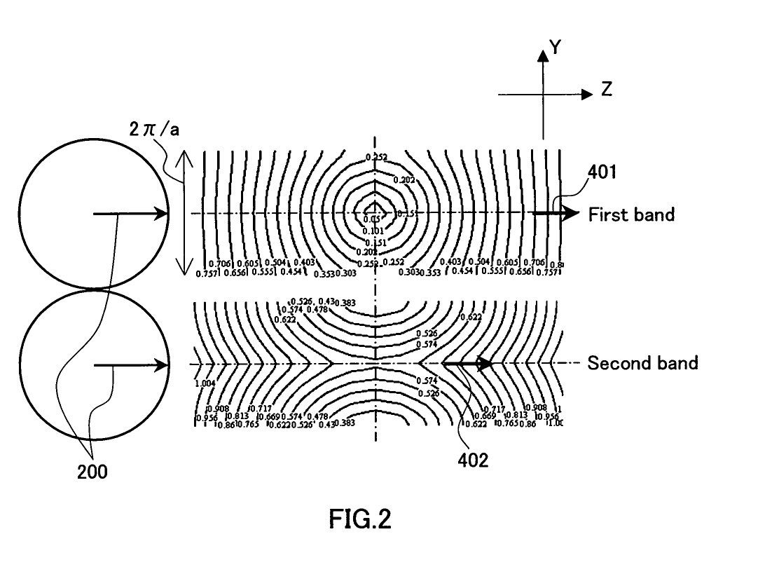

Hereinafter, the propagation of the propagation light 4 in the photonic crystal 1 when the incident light 2 that is a plane wave is incident from the incident end face 1a of the photonic crystal 1 will be considered with reference to FIG. 2 as well as FIG. 1. FIG. 2 is a band diagram of the photonic crystal 1 shown in FIG. 1, which also includes the incident light 2. In FIG. 2, the right side shows a band diagram in the photonic crystal 1, and the left side shows a band diagram of a homogeneous medium (air) on an outer side (portion where the incident light 2 is incident) of the photonic crystal 1.

The conditions of the photonic crystal 1 at this time are as follows. First, the refractive index n_{A} of the material 5a is 2.1011, and the thickness t_{A} thereof is represented using the period a in the following manner t_{A}=0.3a. Furthermore, the refractive index n_{B} of the material 5b is 1.4578, and the thickness t_{B} thereof is represented using the period a in the following manner: t_{B}=0.7a. FIG. 2 shows results of band calculation in the Y-axis and Z-axis directions of the photonic crystal 1 that is a multi-layered structure with the period a in which the materials 5a and 5b are layered alternately. In the photonic crystal 1, it is assumed that surface of each layer of the materials 5a and 5b spreads infinitely in an XZ-plane, and is layered infinitely in the Y-direction. FIG. 2 shows the first and second bands of TE polarized light in a first Brillouin zone range. The band diagram in the photonic crystal 1 shown on the right side of FIG. 2 is represented in a contour shape where points at which normalized frequencies ωa/2πc have the same value are connected, and hereinafter, lines of the contour shape will be referred to as contour lines. A suffix of each line represents the value of the normalized frequency ωa/2πc. The normalized frequency ωa/2πc is represented using an angular frequency ω of the incident light 2, a period a of the photonic crystal 1 and a speed of light c in vacuum. The normalized frequency also can be represented as a/λ₀ using the wavelength λ₀ of the incident light 2 in vacuum. Hereinafter, the normalized frequency ωa/2πc will be described simply as the normalized frequency a/λ₀.

In FIG. 2, the range in the Y-axis direction of the Brillouin zone is ±π/a (the width in the Y-axis direction of the Brillouin zone is 2π/a); however, in the Z-axis direction, there is no boundary of the Brillouin zone due to the absence of periodicity, so that contour lines spread infinitely. The TE polarized light refers to polarized light with an electric field being in the X-axis direction. Furthermore, the band diagram of TM polarized light (with a magnetic field being in the X-axis direction) that is polarized light with a magnetic field being in the X-axis direction is similar to that of the TE polarized light with some differences.

An arrow 401 represents an energy traveling direction of the first band of the propagation light 4 in the photonic crystal 1. Furthermore, an arrow 402 represents an energy traveling direction of the second band of the propagation light 4 in the photonic crystal 1.

Furthermore, the band diagram of a homogeneous medium (air) on an outer side of the photonic crystal 1 shown on the left side of FIG. 2 is in the shape of a sphere (circle in an YZ-plane) whose radius r is represented by the following expression. In the expression, n represents a refractive index of a medium (homogenous medium on an outer side of the photonic crystal 1) that is in contact with the incident end face 1a.
r=n·(a/λ₀)·(2π/a)

(2π/a) on the right side of the above expression is a coefficient for correspondence with the band diagram (FIG. 2) of the photonic crystal. An arrow 200 represents a wave vector of the incident light 2.

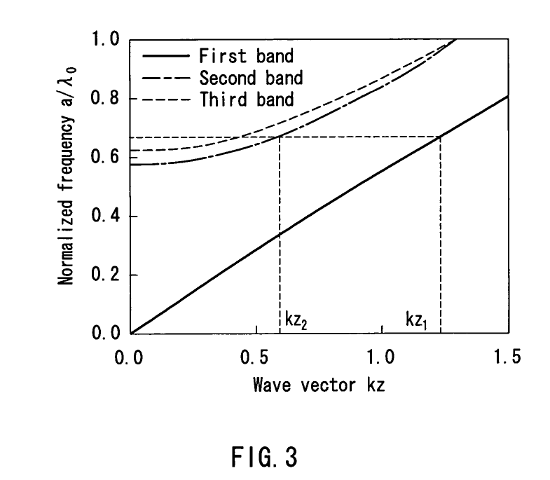

FIG. 3 is a band diagram in which the band diagram in FIG. 2 is limited in the Z-direction with respect to the Brillouin zone center. A vertical axis represents a normalized frequency ωa/2πc (=a/λ₀), and a horizontal axis represents the magnitude of a wave vector kz. FIG. 3 also shows a third band. As is understood from FIG. 3, there is a large difference in properties between the first band and the high-order band (second and third bands). That is, the normalized frequency a/λ₀ (vertical axis) of the first band is substantially proportional to the wave vector kz (horizontal axis), so that an effective refractive index hardly varies with respect to a change in λ₀. However, in the high-order band, the effective refractive index greatly varies depending upon λ₀, and the value of a/λ₀ is almost constant even when kz approaches 0. That is, the effective refractive index sometimes becomes less than 1.

Furthermore, it is well known that a value (i.e., a slope of a tangent) obtained by differentiating a band curve shown in FIG. 3 with kz is a group velocity of propagation light. In the case of FIG. 3, in the high-order band, as the value of kz decreases, the slope of a tangent of the band curve decreases rapidly and becomes 0 when kz=0. This is a group velocity abnormality peculiar to the photonic crystal. The group velocity abnormality in the photonic crystal is very large, and is opposite to the dispersion of an ordinary homogeneous material (group velocity becomes small as the wavelength of incident light increases). Thus, the optical waveguide capable of using high-order band light can be used for a light control element such as an optical delay element and a dispersion compensating element in optical communication.

In the case where the incident light 2 with a wavelength λ₀ in vacuum is vertically incident upon the end face 1a of the photonic crystal 1, and there are a plurality of propagation vectors with respect to this light, in the photonic crystal 1, there are propagation light with a wave vector kz₁ by the lowest-order band (first band) and propagation light with a wave vector kzᵢ (i=2, 3, 4 . . . ) by a high-order band higher than the lowest-order band. If the band with respect to the incident light 2 is only the lowest-order band, only the propagation light in the first band propagates in the photonic crystal 1. The wavelength of the propagation light in the photonic crystal 1 is as follows: the wavelength of the propagation light in the first band is represented as λz₁=2π/kz₁, and the wavelength of the propagation light in the high-order band is represented as λz₂=2π/kz₂. In the photonic crystal 1, the traveling directions of each propagation light 4 are those (directions represented by arrows 401 and 402) normal to the contour lines shown in FIG. 2. Therefore, the propagation light 4 by any band also propagates in the Z-axis direction.

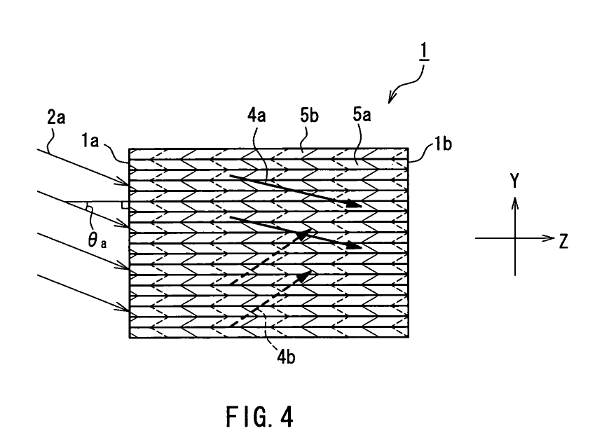

Next, the case where the incident light 2a is incident obliquely upon the end face 1a of the photonic crystal 1 shown in FIG. 1 will be described. FIG. 4 is a cross-sectional view showing the propagation of light in a photonic crystal in the case where incident light is incident obliquely upon an incident end face. As shown in FIG. 4, when the incident light 2a is incident upon the incident end face 1a of the photonic crystal 1 at an incident angle θₐ, the propagation light 4a and 4b propagates in the photonic crystal 1. The incident angle is the one formed by a line normal to the incident end face 1a and the incident light 2a.

The propagation light 4a and 4b in FIG. 4 will be described further with reference to FIG. 5 as well as FIG. 4. FIG. 5 is a band diagram of the photonic crystal shown in FIG. 4, which also includes incident light. In FIG. 5, the right side shows a band diagram in the photonic crystal 1, and the left side shows a band diagram of a homogeneous medium (air) on an outer side (portion where the incident light 2a is incident) of the photonic crystal 1. The wavelength of the incident light 2a in vacuum is λ₀. The band diagram of a homogenous medium (air) on an outer side of the photonic crystal 1 shown on the left side of FIG. 5 is in the shape of a sphere whose radius r is represented by the following expression.
r=n·(a/λ₀)·(2π/a)

Furthermore, an arrow 201 represents a wave vector of the incident light 2a.

In FIG. 5, the energy traveling directions of the propagation light 4a and 4b with which the incident light 2a is combined in the photonic crystal 1 are directions normal to the contour lines at points 405 and 406. Because of this, the energy traveling directions of the propagation light 4a in the first band and the propagation light 4b in the second band are represented respectively by the arrows 403 and 404. That is, the propagation light 4a in the first band and the propagation light 4b in the second band propagate in directions different from each other.

Herein, in the case where an incident angle θ satisfies the condition of the following expression (1), the incident light 2a is combined with the first and second bands on the Brillouin zone boundary to propagate.
n·sinθ·(a/λ₀)=0.5 (1)

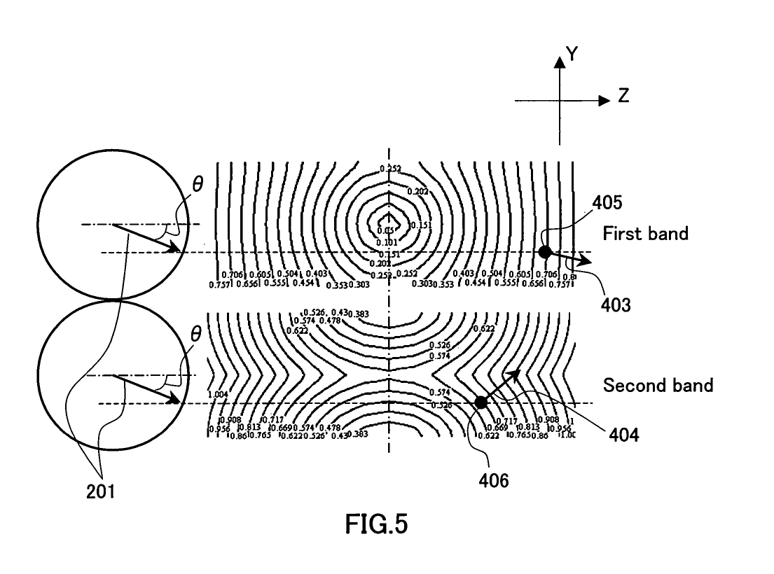

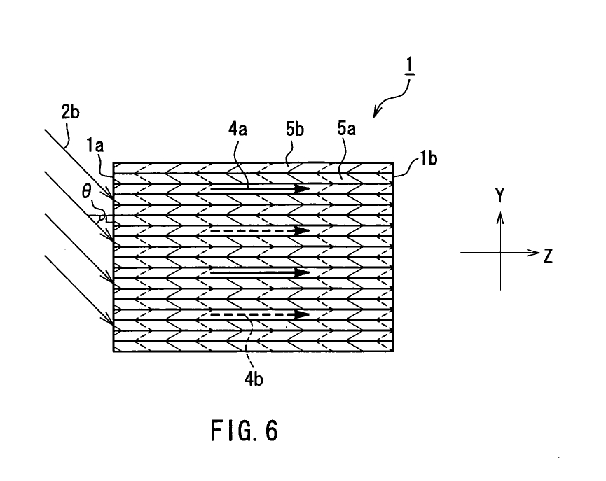

On the Brillouin zone boundary, owing to the symmetry of the bands, the traveling direction of wave energy is matched with a Z-axis. FIG. 6 is a cross-sectional view showing the state where propagation light propagates in the Z-axis direction in the case where incident light is incident obliquely upon an incident end face of a photonic crystal. Furthermore, FIG. 7 is a band diagram of the photonic crystal shown in FIG. 6, which also includes incident light.

The incident light 2b shown in FIG. 6 is different from the incident light 2a shown in FIG. 4 with respect to an incident angle. In FIG. 6, the incident angle θ of the incident light 2b satisfies Expression (1). From FIG. 7, an arrow 202 that is a wave vector of the incident light 2b is drawn, and the energy traveling directions of the propagation light 4a and 4b in the first and second bands are obtained respectively. Arrows 407 and 408 representing the energy traveling directions of the propagation light 4a and 4b in the first and second bands are obtained (see FIG. 7). As is understood from the arrows 407 and 408, the propagation light 4a and 4b travel in the Z-axis direction (see FIG. 6). Considering the periodicity in the Y-direction of the Brillouin zone, in order for the propagation light 4a and 4b to propagate in the Z-axis direction, the incident light 2b may be incident upon the incident end face 1a at the incident angle θ satisfying the following Expression (2).
n·sinθ·(a/λ₀)=1.0, 1.5, 2.0 . . . (2)

However, as the value increases, it is necessary to set n and θ to be large values, so that it is difficult to realize the incidence of the incident light 2b at the incident angle θ represented by the above Expression (2). Thus, the condition represented by the above Expression (1) is the most practical.

In an actual optical system, a deviation from the condition of Expression (1) may be caused. The object of the present embodiment can be achieved, as long as this deviation is about ±10%. More specifically, the incident angle 0 may be in a range satisfying the following Expression (3).
0.45<n·sinθ·(a/λ₀ )<0.55 (3)

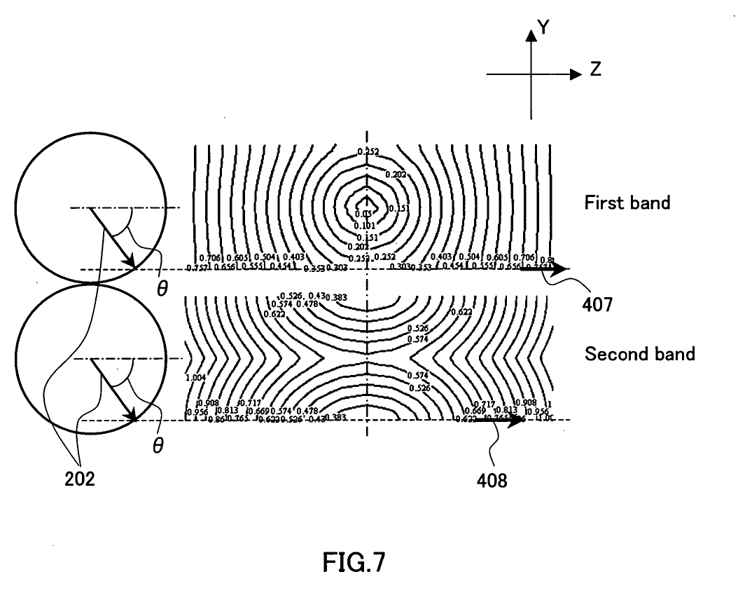

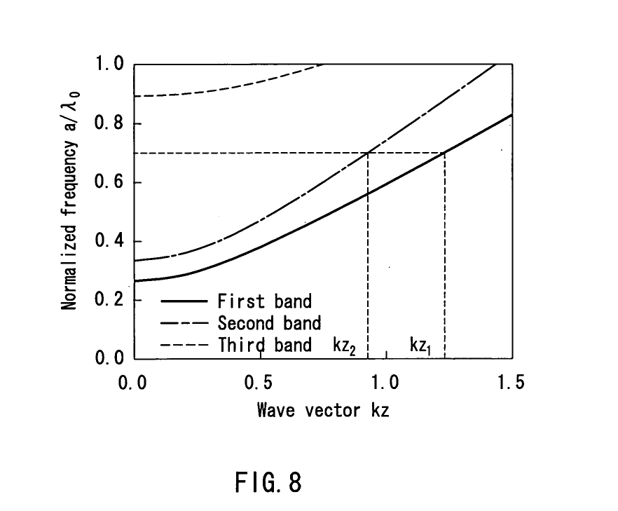

FIG. 8 is a band diagram in which the band diagram in FIG. 7 is limited to the Z-direction with respect to the Brillouin zone boundary. A vertical axis represents a normalized frequency ωa/2πc (=a/λ₀), and a horizontal axis represents the magnitude of a wave vector kz. FIG. 8 also shows a third band.

As shown in FIG. 8, on the Brillouin zone boundary, all the bands including the first band exhibit changes similar to those of the high-order bands (second and third bands) shown in FIG. 3, and it is understood that, by using the bands on the Brillouin zone boundary, the first band light also has properties similar to those of high-order band light. It also is apparent that the wavelengths of propagation light by respective bands vary.

As shown in FIGS. 7 and 8, in the case where the incident light 2a is incident upon the incident end face 1a of the photonic crystal 1 at the incident angle θ that satisfies the condition of Expression (1) in the frequency range in which the propagation light in the first and second bands is present (see FIG. 6), the respective waves of the first and second band light propagate in a direction along the Z-axis. Herein, in the media (materials 5a and 5b) constituting the photonic crystal 1, it is assumed that the refractive index of the material 5a is higher than that of the material 5b. In this case, the propagation light 4a in the first band propagates in the Z-axis direction with the layer of the material 5a having a high refractive index being an antinode of an electric field, and the layer of the material 5b having a low refractive index being a node of an electric field. Furthermore, the propagation light 4b in the second band propagates in the Z-axis direction with the layer of the material 5b having a low refractive index being an antinode of an electric field, and the layer of the material 5a having a high refractive index being a node of an electric field.

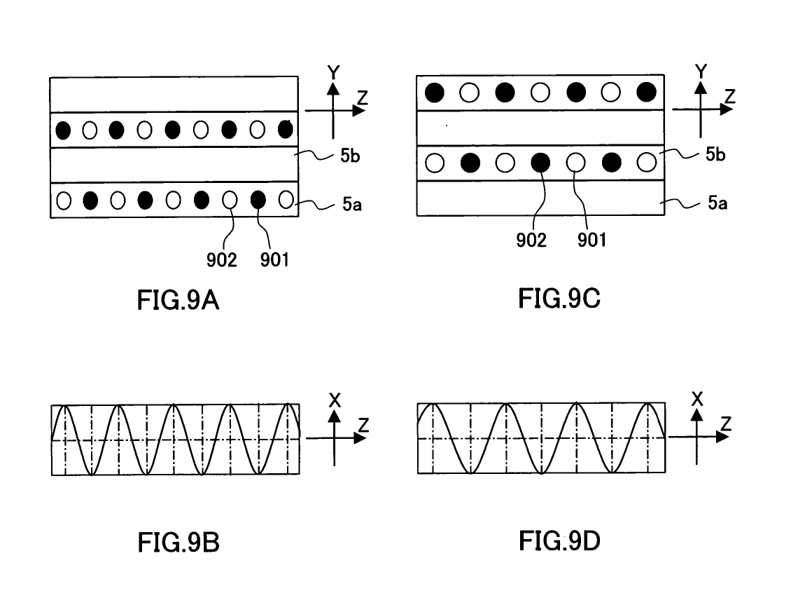

The shapes of the propagation light 4a and 4b in the first and second bands will be described. FIG. 9A is a cross-sectional view schematically showing the shape of the propagation light in the first band, and FIG. 9B is a view showing the amplitude of an electric field when FIG. 9A is seen in the Y-direction. Furthermore, FIG. 9C is a cross-sectional view schematically showing the shape of the propagation light in the second band, and FIG. 9D is a view showing the amplitude of an electric field when FIG. 9C is seen in the Y-direction. In FIGS. 9A and 9C, a top peak 901 (position at which an amplitude of the electric field becomes maximum on a plus side) and a bottom peak 902 (position at which an amplitude of the electric field becomes maximum on a minus side) of the propagation light are shown respectively.

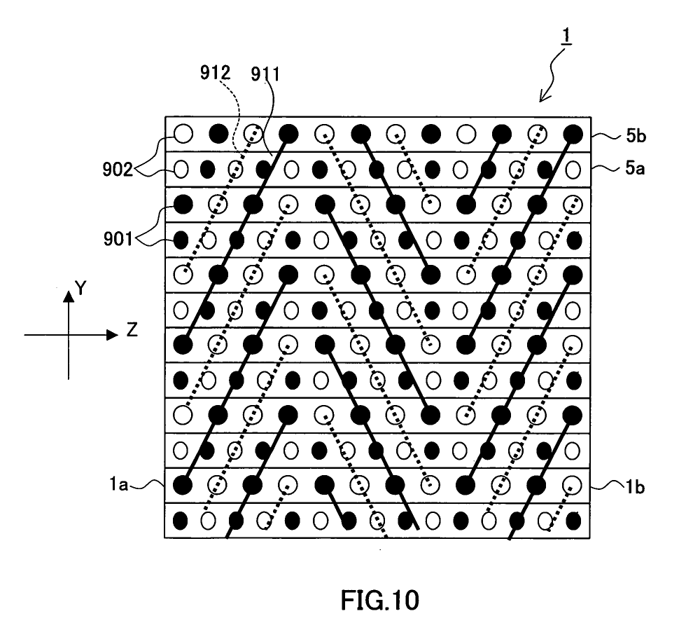

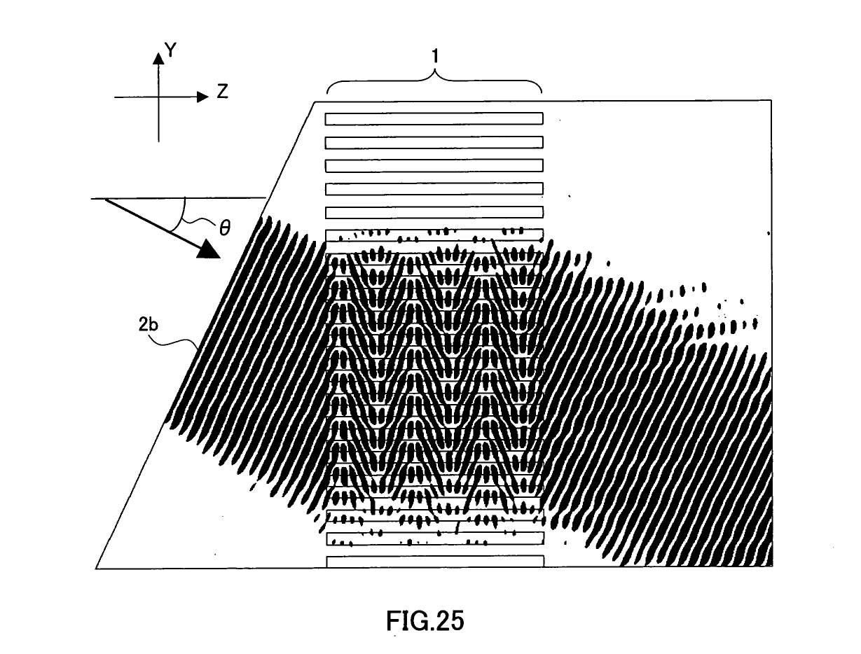

As shown in FIG. 8, the wave vectors kz₁ and kz₂ of the first and second bands in the photonic crystal 1 are different in magnitude, and the interval between the top peak 901 and the bottom peak 902 shown in FIGS. 9C and 9D is longer than that between the top peak 901 and the bottom peak 902 shown in FIGS. 9A and 9B. More specifically, the wavelength of the propagation light 4a in the first band shown in FIGS. 9A and 9B is smaller than that of the propagation light 4b in the second band shown in FIGS. 9C and 9D. FIG. 10 is a cross-sectional view schematically showing the propagation shape of propagation light in which the first band and the second band shown in FIGS. 9A and 9C are overlapped with each other. That is, FIG. 10 shows the shape of propagation light in the case where the light in a frequency range in which both the first and second bands are present is incident upon the photonic crystal 1 at the incident angle θ that satisfies the condition of Expression (1). FIG. 10 is obtained by overlapping FIGS. 9A and 9C and connecting peaks of an electric field with lines. In FIG. 10, each portion connected with a solid line 911 is a top peak of the propagation light, and each portion connected with a broken line 912 is a bottom peak of the propagation light. Furthermore, a characteristic electric field pattern is exhibited, in which the direction of a wave front repeats the top peak (solid line 911) and the bottom peak (broken line 912) alternately (see Calculation Example 1 described later and FIG. 25).

From the above-mentioned band calculation, the respective wavelengths of the propagation light 4a in the first band and the propagation light 4b in the second band in the photonic crystal 1 can be determined to be λz₁=2π/kz₁ and λz₂=2π/kz₂, and a period Λ of the top peak and the bottom peak of the electric field pattern generated by the overlapping of the propagation light 4a in the first band and the propagation light 4b in the second band can be obtained by the following Expression (4).
Λ=(λz₁·λz₂)/(λz₂−λz₁) (4)

A method for allowing the propagation light to perform the above-mentioned “propagation on the Brillouin zone boundary” in the photonic crystal 1 will be described below.

A first method is to allow incident light to be incident obliquely upon an end face of a one-dimensional photonic crystal. More specifically, as shown in FIG. 6, the incident light 2b is allowed to be incident at the incident angle θ that satisfies the condition of Expression (1) (or Expression (2)), approximately Expression (3), under the condition of being tilted with respect to the incident end face 1a of the photonic crystal 1.

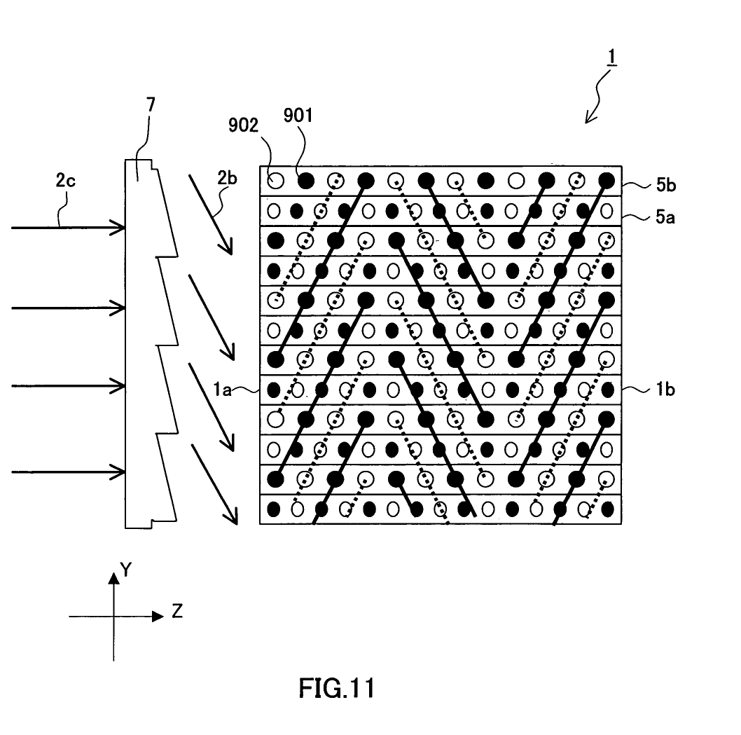

Furthermore, a second method is to allow incident light to be incident obliquely upon an end face of a one-dimensional photonic crystal, using a diffraction grating. FIG. 11 is a cross-sectional view showing a method using a diffraction grating that realizes the propagation on the Brillouin zone boundary in the photonic crystal. More specifically, as shown in FIG. 11, a diffraction grating 7 is placed immediately before the incident end face 1a of the photonic crystal 1. Incident light 2c perpendicular to the incident end face 1a of the photonic crystal 1 is allowed to be incident upon the diffraction grating 7, and the direction of the incident light 2c is changed by the diffraction grating 7. The incident light 2b output from the diffraction grating 7 is allowed to be incident upon the incident end face 1a at the incident angle θ that satisfies the condition of Expression (1) (or Expression (2)), approximately Expression (3).

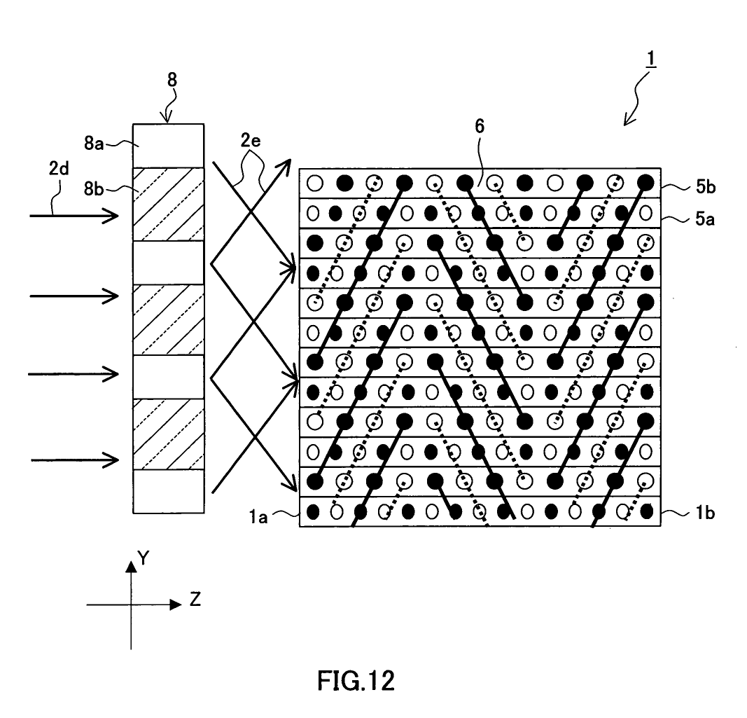

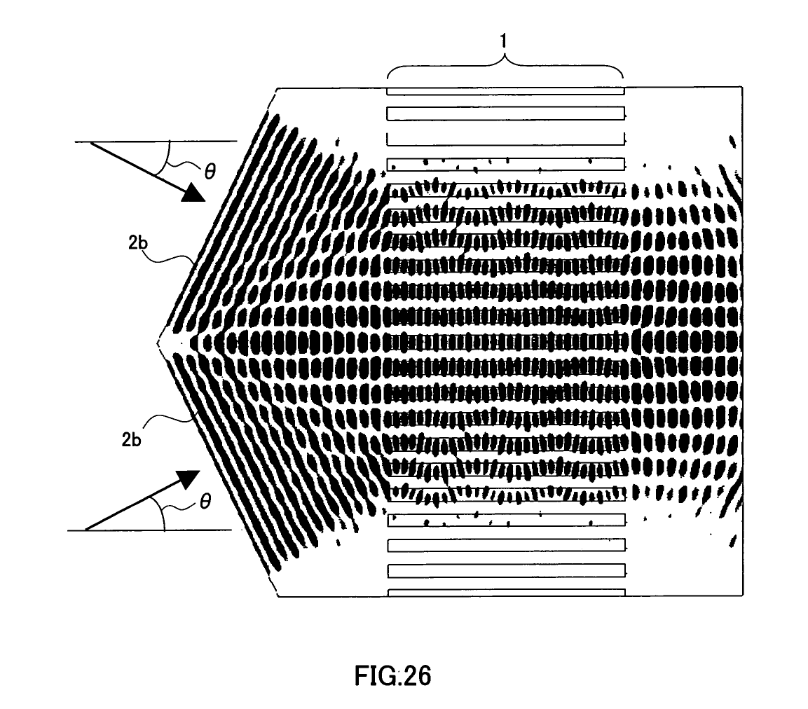

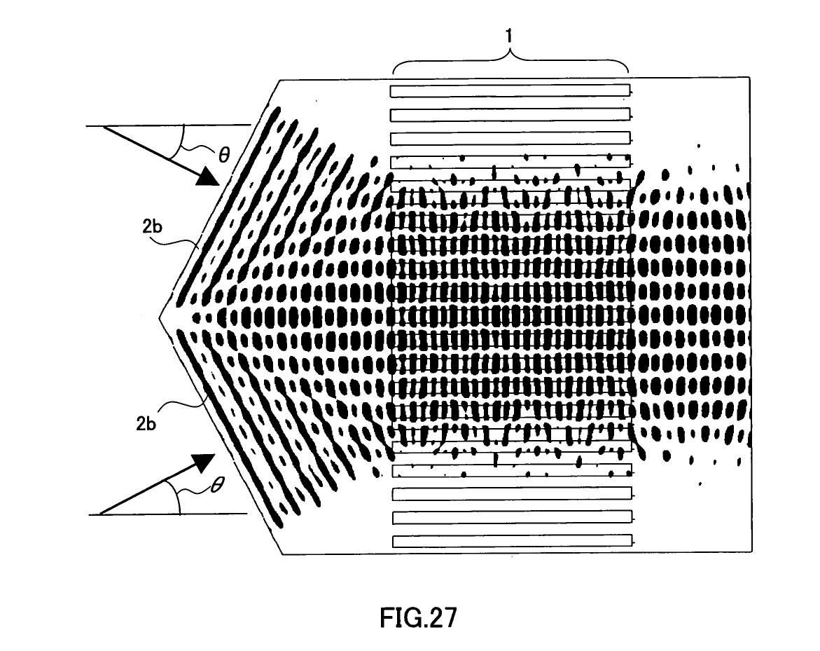

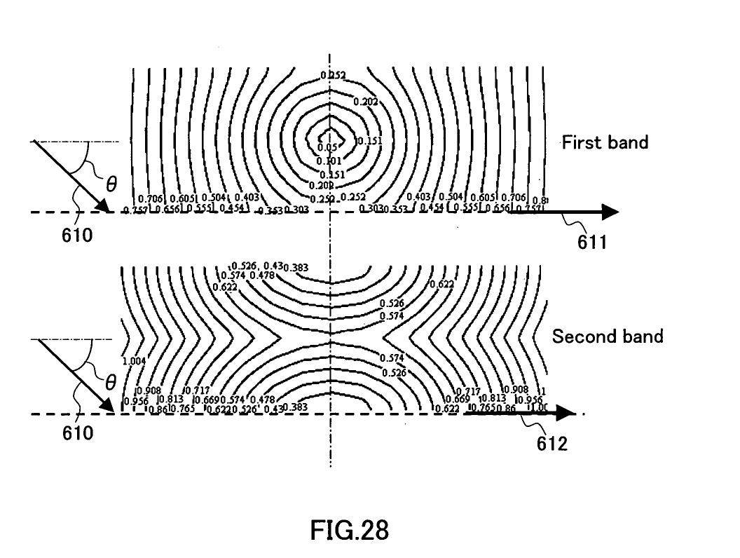

Furthermore, a third method is to allow ±1st-order diffracted light to be incident upon an end face of a one-dimensional photonic crystal using a phase grating. FIG. 12 is a cross-sectional view showing a method using a phase grating that realizes the propagation on the Brillouin zone boundary in the photonic crystal. More specifically, as shown in FIG. 12, the phase grating 8 is placed in the vicinity of or in contact with a front surface of the incident end face 1a of the photonic crystal 1. The phase grating 8 is a one-dimensional photonic crystal in which materials 8a and 8b having different refractive indexes are layered alternately, and the period direction thereof matches that of the photonic crystal 1. The phase grating 8 splits the wave front of incident light into ±1st-order diffracted light. When incident light 2d perpendicular to the incident end face 1a of the photonic crystal 1 is incident upon the phase grating 8, two plane waves 2e (±1st-order light) crossing each other are generated. Because of the interference of the ±1st-order light, an electric field pattern having a node and an antinode is formed. When the photonic crystal 1 and the phase grating 8 are placed so that the material 5a, which is a high-refractive layer, is placed in the portions of antinode and node, only the propagation light by the first band is generated (see the first reference example in Calculation Example 1 described later and FIG. 26). Furthermore, when the photonic crystal 1 and the phase grating 8 are placed so that the material 5b, which is a low-refractive layer, is placed in the portions of antinode and node, only the propagation light by the second band is generated (see a second reference example in Calculation Example 1 described later and FIG. 27).

Herein, when the photonic crystal 1 and the phase grating 8 are adjusted to be placed so that the material 5a, which is a high-refractive layer, and the material 5b, which is a low-refractive layer, are placed in the portions of antinode and node, propagation light by both the first and second bands is generated. Herein, the period of the phase grating 8 is 2a, which is twice the period of the photonic crystal 1.

The output light direction, in which the propagation light in the first band and the propagation light in the second band having propagated in the Z-axis direction by using the bands on the Brillouin zone boundary are output from the exit end face 1b of the photonic crystal 1, are determined by an apparent wave front by a specific electric field pattern.

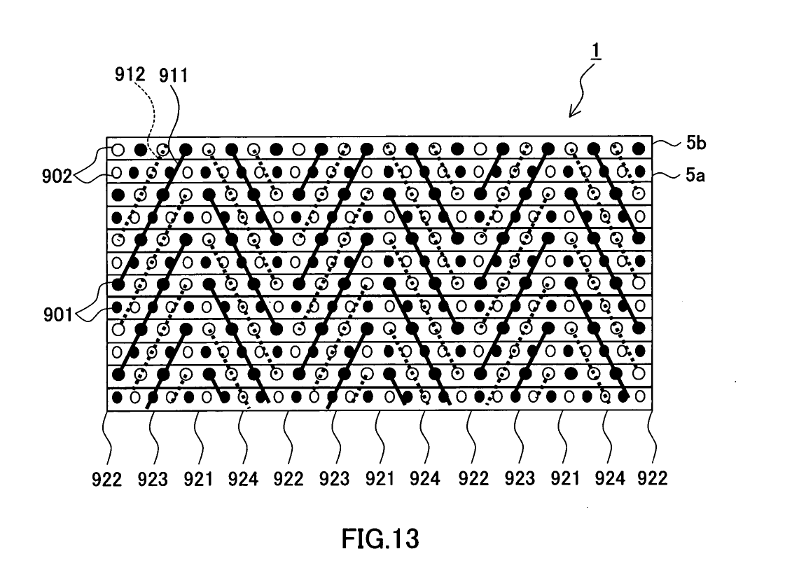

FIG. 13 is a cross-sectional view showing the propagation shape in which the propagation light in the first and second bands on the Brillouin zone boundary is propagating in the photonic crystal. As shown in FIG. 13, due to the top peak 901 and the bottom peak 902 of the propagation light in each band, a top peak of the propagation light generated by each band propagation light represented by the solid line 911 and a bottom peak of the propagation light generated by each band propagation light represented by the broken line 912 are present. FIG. 13 shows a position 921 of the top peak of the propagation light, a position 922 of the bottom peak of the propagation light, an intermediate position 923 between the bottom peak and the top peak of the propagation light, and an intermediate position 924 between the top peak and the bottom peak of the propagation light. The state of output light varies among the case where the position of the exit end face is placed at the position 921 of the top peak or the position 922 of the bottom peak, the case where the position of the exit end face is placed at the intermediate position 923 between the bottom peak and the top peak, and the case where the position of the exit end face is placed at the intermediate position 924 between the top peak and the bottom peak.

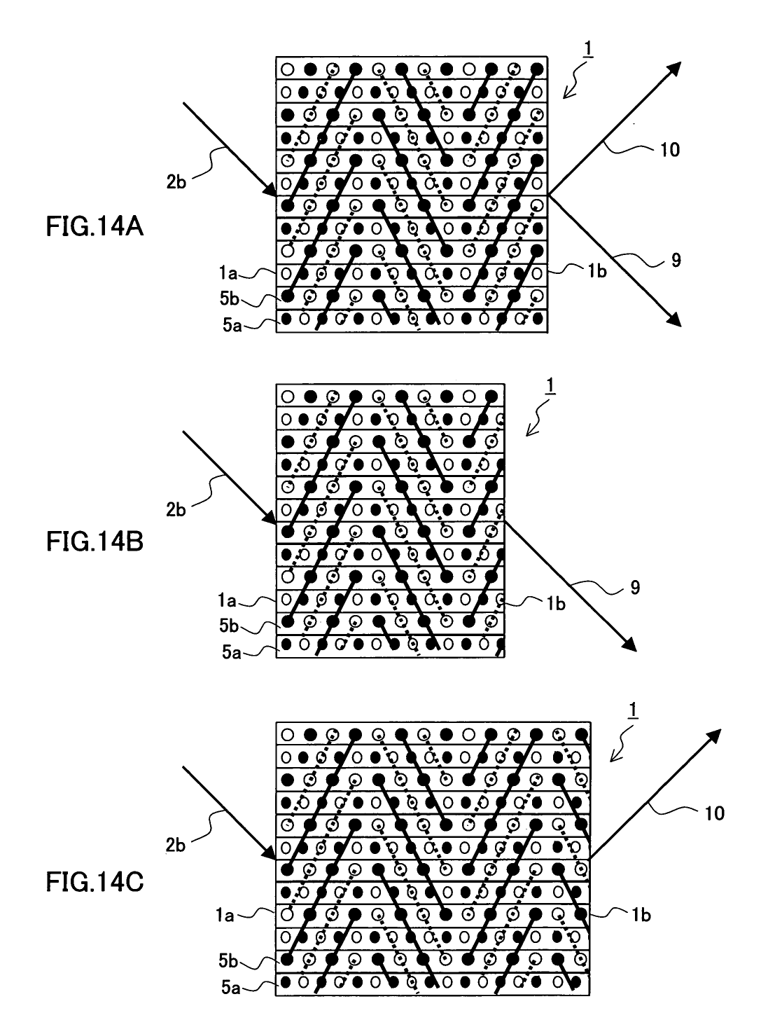

The state of each output light at the position of each exit end face will be described with reference to FIGS. 14A, 14B, and 14C. FIG. 14A is a cross-sectional view showing output light in the case where the position of the exit end face in the photonic crystal shown in FIG. 13 is a position of a top peak or bottom peak of the propagation light. FIG. 14B is a cross-sectional view showing output light in the case where the position of the exit end face shown in FIG. 13 is an intermediate position between the bottom peak and the top peak of the propagation light. FIG. 14C is a cross-sectional view showing output light in the case where the position of the exit end face shown in FIG. 13 is an intermediate position between the top peak and the bottom peak of the propagation light.

In FIGS. 14A, 14B, and 14C, although the propagation light is allowed to perform “propagation on the Brillouin zone boundary” in the photonic crystal 1 by the above-mentioned first method, the second or third method may be used.

As shown in FIG. 14A, the case where the position of the exit end face 1b of the photonic crystal 1 is placed at the position 921 of the top peak of the propagation light shown in FIG. 13 will be described. The propagation light in the first band and the propagation light in the second band having propagated through the high-refractive layer (material 5a) and the low-refractive layer (material 5b) are diffracted at the exit end face 1b, and two output light: 0th-order light 9 and 1st-order diffracted light 10 in different directions are emitted from the exit end face 1b. The diffraction direction is determined by the period a of the materials 5a and 5b of the one-dimensional photonic crystal 1, so that the diffraction direction of the propagation light in the first band becomes equal to that of the propagation light in the second band. Therefore, output light appears in two directions (see Calculation Example 3 described later and FIG. 31). Even in the case where the exit end face 1b is placed at the position 922 of a bottom peak of the propagation light, output light also appears in two directions similarly.

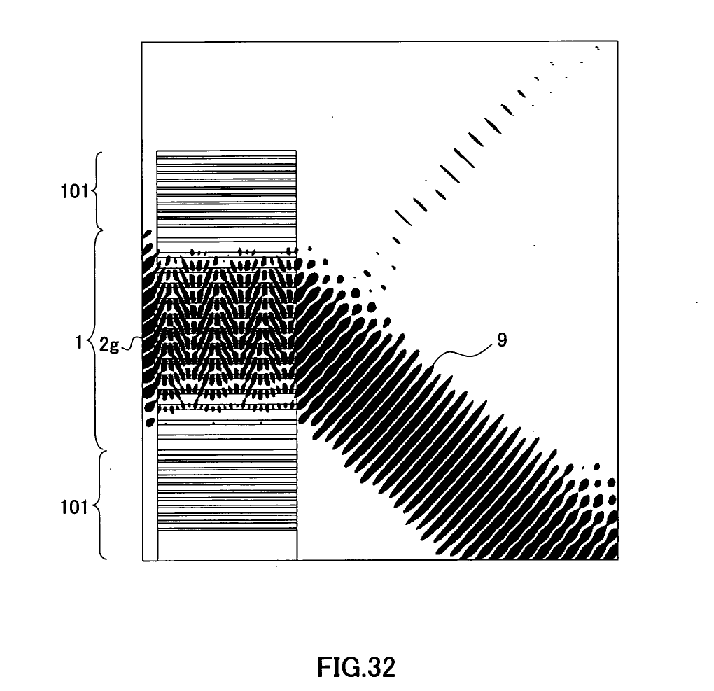

Furthermore, as shown in FIG. 14B, the case where the position of the exit end face 1b of the photonic crystal 1 is placed at the intermediate position 923 between the bottom peak and the top peak of the propagation light will be described. In FIG. 14B, the propagation light in the first band and the propagation light in the second band are diffracted at the exit end face 1b to be output. Each 1st-order diffracted light of the propagation light in the first and second bands cancels each other due to the shift by a half wavelength, and output under the condition that the 0th-order light 10 strengthens each other (see Calculation Example 4 described later and FIG. 32).

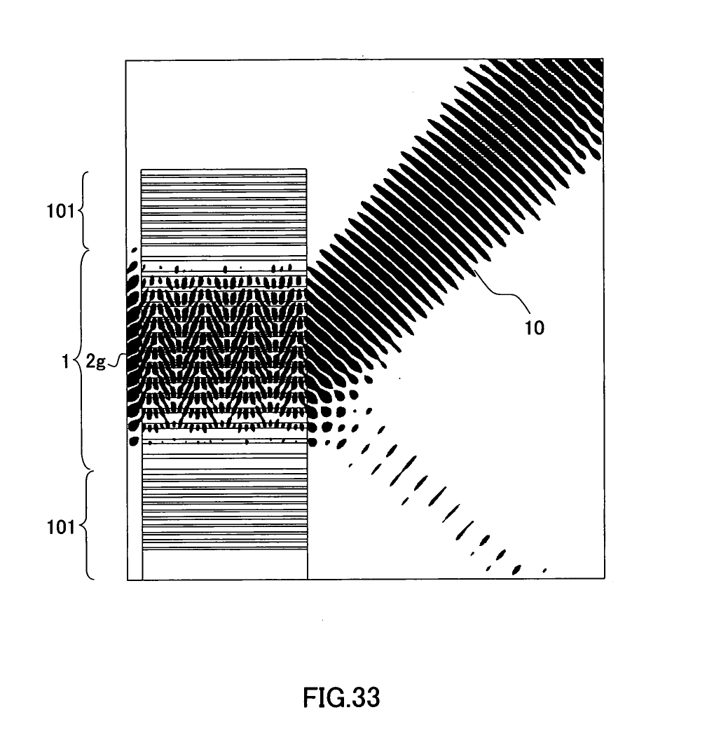

Furthermore, as shown in FIG. 14C, the case where the position of the exit end face 1b of the photonic crystal 1 is placed at the intermediate position 924 between the top peak and the bottom peak of the propagation light will be described. The propagation light in the first band and the propagation light in the second band are diffracted at the exit end face 1b to be output. In FIG. 14C, each 0th-order light of the propagation light in the first and second bands cancels each other due to a shift by a half wavelength, and output under the condition that the 1st-order diffracted light 9 strengthens each other (see Calculation Example 5 described later and FIG. 33).

Thus, the radiation direction of output light varies greatly depending upon the position of the exit end face 1b. More specifically, for example, if the state shown in FIG. 14B and the state shown in FIG. 14C can be switched, an optical path conversion element can be realized. As a method for switching the state shown in FIG. 14B and the state shown in FIG. 14C, the following two methods are considered.

First, a method for changing the photonic band structure of the photonic crystal 1 is considered. The photonic band structure can be changed by “changing the refractive index of a medium constituting a photonic crystal that is a periodic structure” or by “directly changing the period of a photonic crystal that is a periodic structure”. When the photonic band structure changes, each propagation period of the propagation light in the first band and the propagation light in the second band, propagating in the photonic crystal 1, changes. Consequently, the period Λ of a top peak and a bottom peak of the characteristic propagation shape generated by the overlapping of these two waves changes, and the electric field pattern of the propagation light at the exit end face 1b changes. By controlling this change, for example, the states of FIGS. 14B and 14C can be switched selectively and practically. Thus, the radiation direction of output light at the exit end face 1b of the photonic crystal 1 can be switched, which can be used for an optical path conversion element.

Next, an external control device for changing the propagation optical path length (distance from the incident end face 1a to the exit end face 1b) in the photonic crystal 1 is considered. If the propagation optical path length in the photonic crystal 1 through which the incident light 2b propagates can be changed without changing the photonic band structure, the state of FIG. 14B and the state of FIG. 14C can be formed selectively. That is, the size of the propagation direction (Z-axis direction) of light in the photonic crystal 1 is changed, whereby the state of FIG. 14B and the state of FIG. 14C can be formed. The photonic crystal 1 does not have a periodicity in a direction along an optical path. Therefore, even when the size of the photonic crystal is changed by applying an external force in the direction of an optical path, the photonic band structure itself does not change. The change in a refractive index by compression can be ignored.

The optical path conversion element of the present embodiment using the above method will be described more specifically with reference to the drawings.

### Embodiment 1

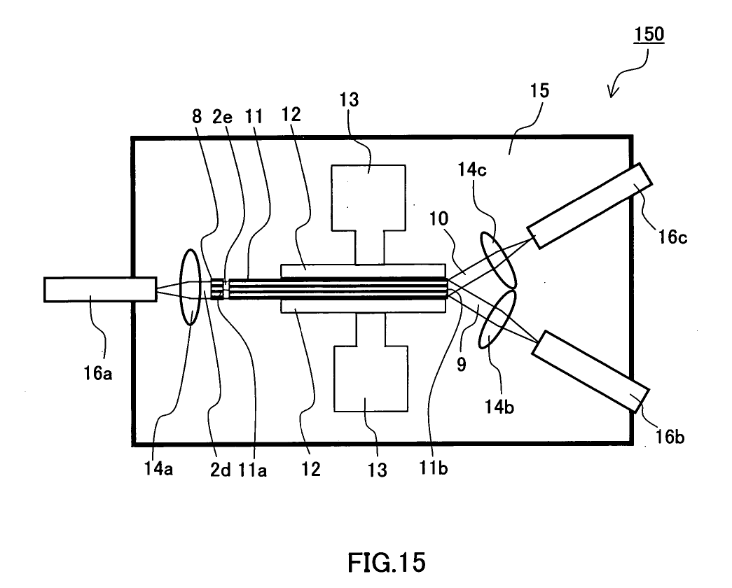

An optical path conversion element according to Embodiment 1 of the present invention will be described. FIG. 15 is a plan view showing a configuration of the optical path conversion element according to Embodiment 1.

As shown in FIG. 15, in an optical path conversion element 150 of Embodiment 1, a photonic crystal 11 is formed on a substrate 15. The photonic crystal 11 is a one-dimensional photonic crystal having a periodic structure in a direction parallel to the surface of the substrate 15. It is assumed that at least one of media constituting the photonic crystal 11 is formed of a material having an electro-optic effect. The material having an electro-optic effect refers to the one whose refractive index is changed by applying an electric field. Since an electric field that is external energy is applied to the photonic crystal 11, parallel electrodes 12 that are portions for applying a voltage are placed on both surfaces (surfaces perpendicular to the period direction) of the photonic crystal 11. On the substrate 15, wiring pads 13 in electrical contact with the parallel electrodes 12 are placed. A DC voltage can be applied between the parallel electrodes 12 via the wiring pads 13. By applying a DC voltage between the parallel electrodes 12, the refractive index of the material having an electro-optic effect in the photonic crystal 11 can be changed.

On an incident end face 11a side of the photonic crystal 11, a phase grating 8 that is an incident part is placed. On an incident end side of the phase grading 8, an incident side lens 14a and an incident side optical fiber 16a are placed. On an exit end face 11b side of the photonic crystal 11, a first output side converging lens 14b and a first output side optical fiber 16b, and a second output side converging lens 14c and a second output side optical fiber 16c are placed so as to correspond to the respective directions of output light. The phase grating 8, the incident side lens 14a, the incident side optical fiber 16a, th first output side converging lens 14b, the first output side optical fiber 16b, the second output side converging lens 14c, and the second output side optical fiber 16c are placed on the substrate 15.

In order to produce the photonic crystal 11, for example, as disclosed by JP 2002-169022 A, the substrate 15 may be processed directly to produce a periodic multi-layered structure. Specifically, for example, a stripe-shaped pattern is formed on a Si substrate (substrate 15) with a thickness of 1 mm by a photolithography technique, whereby a mask for etching is formed. Next, reactive ion etching is performed through this mask. According to this method, deep grooves whose side walls are substantially perpendicular to the surface of the Si substrate can be formed on the Si substrate. The ratio between the depth of each groove to the width thereof is assumed to be about 10, for example. The Si substrate on the periphery of the groove is etched to form only each wall portion between the grooves into a convex part, whereby a periodic multi-layered structure of Si and air can be obtained. A liquid organic molecular material having an electro-optic effect is injected into an air layer (groove) portion and cured by heating, whereby the photonic crystal 11 can be obtained.

The incident side lens 14a, the first output side converging lens 14b, the second output side converting lens 14c, and the phase grating 8 also can be produced by previously forming a mask corresponding to each member on the Si substrate (substrate 15), and etching the Si substrate simultaneously with the formation of the periodic multi-layered structure to form convex parts. Furthermore, if guide grooves (not shown) for the incident side optical fiber 16a, the first output side optical fiber 16b, and the second output side optical fiber 16c are formed in the substrate 15, these members can be fixed at predetermined positions.

The operation of the optical path conversion element 150 of Embodiment 1 will be described. Incident light 2d propagating in the incident side optical fiber 16a is incident upon the phase grating 8 through the incident side lens 14a. Incident light 2e output from the phase grating 8 is incident upon the photonic crystal 11. The photonic crystal 11 is supplied with an appropriate voltage via the parallel electrodes 12 and the wiring pads 13, and the photonic band structure can be changed with the voltage. That is, by controlling the voltage, the output light output from the exit end face 1b can be switched selectively between 0th-order light 9 and the 1st-order diffracted light 10. In the case where the output light is the 0th-order light 9, the 0th-order light 9 is converged by the first output side converging lens 14b, and combined with the first output side optical fiber 16b. Furthermore, in the case where the output light is the 1st-order diffracted light 10, the 1st-order diffracted light 10 is converged by the second output-side converging lens 14c, and combined with the second output side optical fiber 16c.

As described above, the propagation light propagating in the photonic crystal 11 realizes the propagation on the Brillouin zone boundary so that the first and second bands travel in the Z-axis direction. By controlling the applied voltage to an appropriate value, the exit end face 1b is placed at an intermediate position between the bottom peak and the top peak of the propagation light as shown in FIG. 14B, or the exit end face 1b is placed at the intermediate position between the top peak and the bottom peak of the propagation light as shown in FIG. 14C. Thus, the optical path conversion element 150 of Embodiment 1 can convert an optical path selectively. Furthermore, for example, a photoreceptor can be provided instead of the first and second output side optical fibers 16b and 16c so as to convert incident light to an electric signal selectively.

Furthermore, at least one of the media constituting the photonic crystal 11 may be a semiconducting material, and the remaining may be a material having conductivity. A current is allowed to flow to the parallel electrodes 12 that are current injecting parts through the wiring pads 13, and a current is allowed to flow to the photonic crystal 11 through the parallel electrodes 12, whereby carriers can be injected to the photonic crystal 11. This can change the refractive index of the media constituting the photonic crystal 11 to change the photonic band structure.

Furthermore, at least one of the media constituting the photonic crystal 11 may be an acousto-optic material. The acousto-optic material refers to the one whose refractive index is changed by a sound wave such as an ultrasonic wave. In this case, the refractive index can be changed by applying an ultrasonic wave to the photonic crystal 11 as external energy. That is, in FIG. 15, an ultrasonic wave applying part such as a piezoelectric element for applying an ultrasonic wave to the photonic crystal 11 may be provided instead of the parallel electrodes 12, and a voltage may be applied to the ultrasonic wave applying part from the wiring pads 13. As the piezoelectric element, for example, piezoelectric ceramics such as PZT (Pb(Zr_{0.52}Ti_{0.48})O₃) may be used. Because of this, the photonic band structure of the photonic crystal 11 can be changed.

A part or an entirety of at least one of the media constituting the photonic crystal 11 may be a non-linear optical material. In this case, the refractive index can be changed by irradiating the photonic crystal 11 with control light as external energy. Since only a portion that is irradiated with control light may be formed of a non-linear optical material, a part or an entirety of at least one of the media constituting the photonic crystal 11 may be formed of a non-linear optical material.

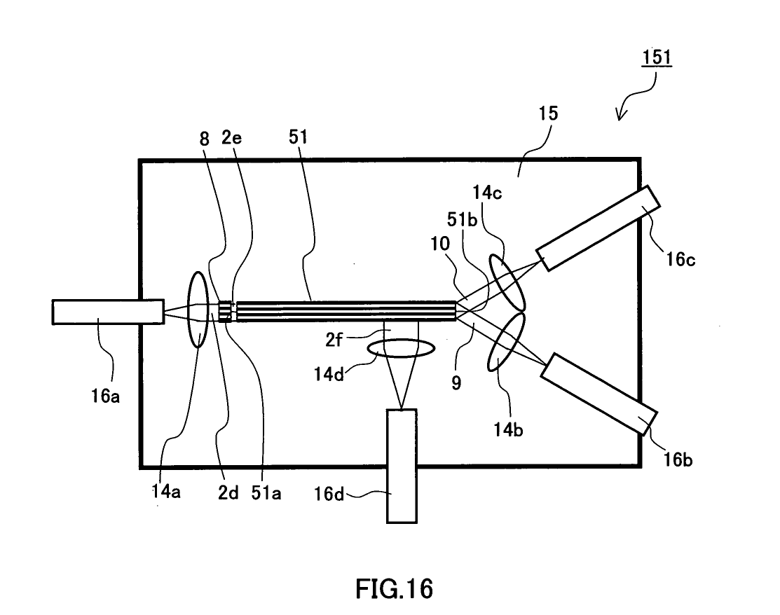

FIG. 16 is a plan view showing a configuration of another optical path conversion element according to Embodiment 1. An optical path conversion element 151 in FIG. 16 has a configuration in which the parallel electrodes 12 and the wiring pads 13 are removed from the optical path conversion element 150 shown in FIG. 15, and a control optical fiber 16d and a control lens 14d are provided instead. Furthermore, a part or an entirety of at least one of the media constituting the photonic crystal 11 is formed of a non-linear optical material. The photonic crystal 51 can be produced easily by etching the Si substrate (substrate 15) to form grooves, and injecting a polymer material with a large tertiary non-linear optical effect in the grooves partially or entirely. The control optical fiber 16d and the control lens 14d are placed on the substrate 15 so that control light 2f from the control optical fiber 16d radiates to a material of the photonic crystal 51 having a large non-linear optical effect via the control lens 14d. In the optical path conversion element 151 thus configured, the intensity of the control light 2f is adjusted, whereby the photonic band structure of the photonic crystal 51 can be changed to selectively convert an optical path of output light. The direction in which the control light 2f radiates to the photonic crystal 51 may be a direction other than those shown in the figure.

Furthermore, in addition to the above method, examples of the external energy for changing the refractive index of the media constituting the photonic crystal include the application of a magnetic field, heating, and the like. The external energy for changing the photonic band structure is selected depending upon the constituent material of the photonic crystal, and the photonic band structure of the photonic crystal is changed with the external energy, whereby the optical path of output light of the photonic crystal may be converted.

If the change in a refractive index of the media constituting a one-dimensional photonic crystal is about 0.01 to 1%, the length required for the photonic crystal may be several 10 μm even in a region where the change in a propagation vector kz is small, and may be several μm in a region where the change in the propagation vector kz is large. Thus, the optical path conversion element 150 or 151 of Embodiment 1 can be miniaturized and integrated (see Calculation Examples 6, 7 described later and FIG. 33).

In Embodiment 1, in order to generate propagation light by a band on the Brillouin zone boundary in the photonic crystal, the phase grating 8 is used. However, propagation light by a band on the Brillouin zone boundary may be generated by using a diffraction grating and allowing light to be incident obliquely.

### Embodiment 2

An optical path conversion element according to Embodiment 2 of the present invention will be described. The optical path conversion element according to Embodiment 2 changes the photonic band structure of a photonic crystal by directly changing the period of a periodic structure of a photonic crystal with an external force.

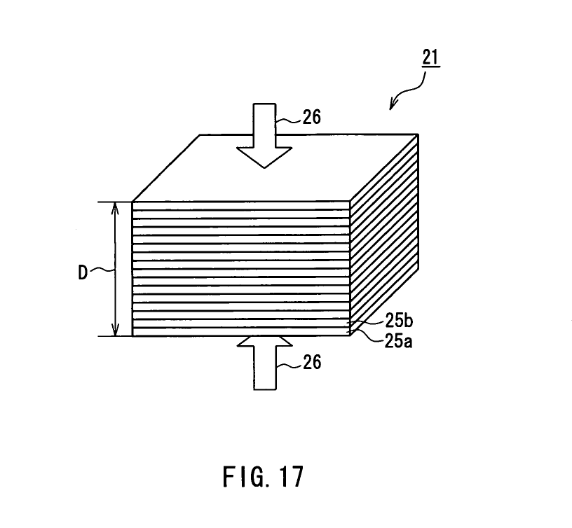

FIG. 17 is a schematic view illustrating a method for directly changing the period of a photonic crystal. In FIG. 17, a one-dimensional photonic crystal 21 is configured in such a manner that materials 25a and 25b are layered alternately at a constant period. In the case where the size in the period direction (thickness of each layer (materials 25a and 25b)) of the photonic crystal 21 is changed, a mechanical external force 26 may be applied directly in the layering direction. Specifically, the external force 26 may be applied from surfaces of the photonic crystal 21 perpendicular to the period direction to the photonic crystal 21. By applying the external force 26, a thickness D in the period direction of the photonic crystal 21 decreases. Because of this, the wave vectors kz of the propagation light in the first band and the high-order band propagating in the photonic crystal 21 change. Therefore, the period Λ between the top peak and the bottom peak of an electric field pattern of the propagation light generated by the overlapping between the propagation light in the first band and the propagation light in the second band also changes, so that the electric field pattern of the propagation light at the exit end face also changes. Thus, the direction of light output after propagating through the photonic crystal 21 can be controlled selectively.

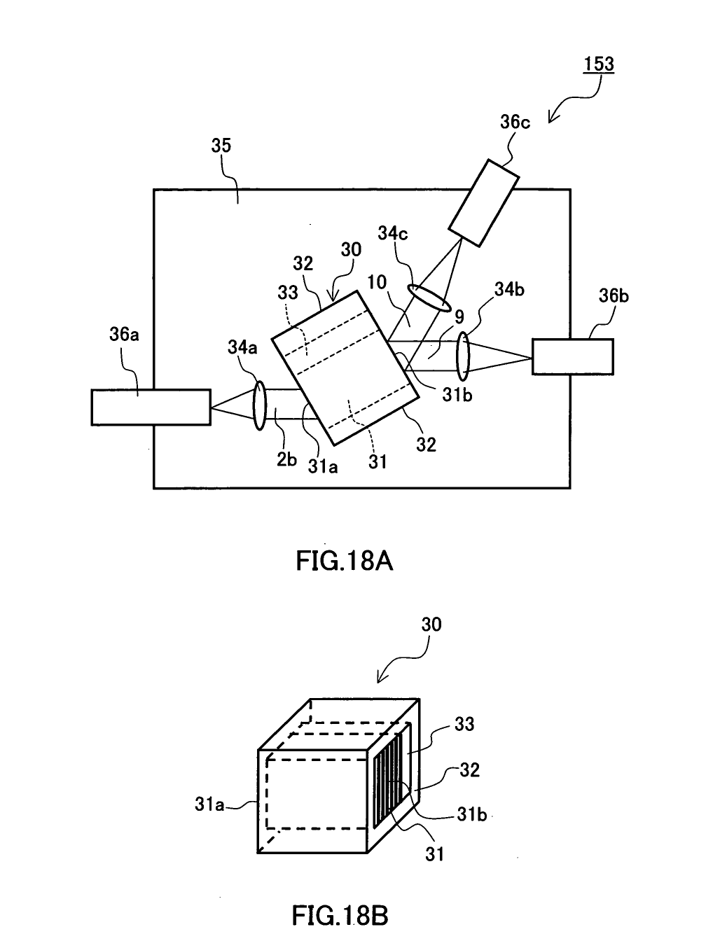

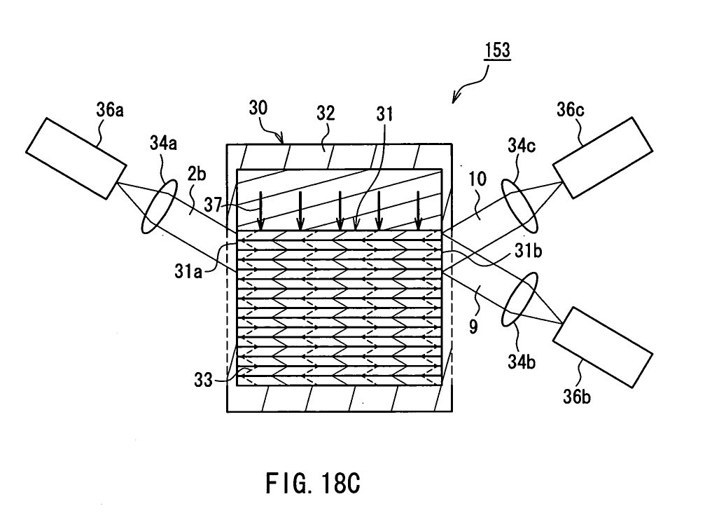

Hereinafter, the optical path conversion element according to Embodiment 2 will be described by showing a specific configuration. FIG. 18A is a plan view showing a configuration of a first optical path conversion element according to Embodiment 2. Furthermore, FIG. 18B is a perspective view showing a configuration of an optical path conversion part of the first optical path conversion element according to Embodiment 2. Furthermore, FIG. 18C is a cross-sectional view schematically illustrating a configuration of the first optical path conversion element according to Embodiment 2. In FIG. 18C, a substrate 35 is omitted.

As shown in FIG. 18A, an optical path conversion element 153 of Embodiment 2 has a configuration in which an optical path conversion part 30, an incident side lens 34a, an incident side optical fiber 36a, a first output side converging lens 34b, a first output side optical fiber 36b, a second output side converging lens 34c, and a second output side optical fiber 36c are placed on the substrate 35.

As shown in FIG. 18B, the optical path conversion part 30 includes a one-dimensional photonic crystal 31 having a periodic structure, a piezoelectric element 33 attached to the photonic crystal 31 so as to be parallel to each layer of the photonic crystal 31, and a support housing 32 that exposes an incident end face 31a and an exit end face 31b of the photonic crystal 31 and covers the other surfaces. It is desirable that the support housing 32 has rigidity, and has small thermal expansion. For example, an Invar alloy or the like preferably is used. An inner surface of the support housing 32 does not expand/contract in the period direction of the photonic crystal 31. That is, the lengths in the period direction of the piezoelectric element 33 and the photonic crystal 31 are fixed by the support housing 32.

The optical path conversion part 30 is fixed on the substrate 35 so that the period direction of the layered films of the photonic crystal 31 is parallel to the surface of the substrate 35. On an incident end face 31a side of the photonic crystal 31, an incident side lens 34a and an incident side optical fiber 36a that correspond to an incident part are placed. On an exit end face 31b side of the photonic crystal 31, the first output side converging lens 34b and the first output side optical fiber 36b, and the second output side converging lens 34c and the second output side optical fiber 36c are placed so as to correspond to the respective directions of output light.

The operation of the optical path conversion element 153 of Embodiment 2 will be described. Incident light 2b having propagated in the incident side optical fiber 36a is incident upon the photonic crystal 31 through the incident side lens 34a. The piezoelectric element 33 is supplied with a voltage from a voltage supplying part (not shown). When the piezoelectric element 33 is supplied with a voltage, the volume thereof increases, and the length of the photonic crystal 31 in the period direction increases. A surface of the photonic crystal 31 opposing a surface that is in contact with the piezoelectric element 33 is fixed in contact with the support housing 32. Because of this, the lengths in the period direction of the piezoelectric element 33 and the photonic crystal 31 are fixed. Therefore, if the length in the period direction of the piezoelectric element 33 increases, the length in the period direction of the photonic crystal 31 decreases. That is, the piezoelectric element 33 is supplied with a voltage, thereby applying an external force 37 to the photonic crystal 31 (see FIG. 18C). Thus, by controlling the voltage supplied to the piezoelectric element 33, the photonic band structure of the photonic crystal 31 can be changed. Specifically, the voltage supplied to the piezoelectric element 33 can switch the output light output from the exit end face 31b of the photonic crystal 31 selectively between 0th-order light 9 and 1st-order diffracted light 10. In the case where the output light is the 0th-order light 9, the 0th-order light 9 is converged by the first output side converging lens 34b, and combined with the first output side optical fiber 36b. Furthermore, in the case where the output light is the 1st-order diffracted light 10, the 1st-order diffracted light 10 is converged by the second output side converting lens 34c, and combined with the second output side optical fiber 36c.

For example, in the case where the piezoelectric element 33 is not supplied with a voltage, each member may be placed so that output light that is 0th-order light 9 is obtained. When the piezoelectric element 33 is supplied with a voltage, each member may be placed so that the direction of output light changes to generate output light that is 1st-order diffracted light 10.

More specifically, first, as described above, the propagation light propagating in the photonic crystal 31 realizes the propagation on a Brillouin zone boundary so that the first and second bands travel in the Z-axis direction as shown in FIG. 6. Furthermore, in this state, the exit end face 1b (31b) is placed at an intermediate position between the bottom peak and the top peak of the propagation light as shown in FIG. 14B, or the exit end face 1b (31b) is placed at an intermediate position between the top peak and the bottom peak of the propagation light as shown in FIG. 14C. Furthermore, by controlling the voltage supplied to the piezoelectric element 33 to an appropriate value, the exit end face 1b (31b) is placed at an intermediate position between the top peak and the bottom peak of the propagation light as shown in FIG. 14C, or the exit end face 1b (31b) is placed at an intermediate position between the bottom peak and the top peak of the propagation light as shown in FIG. 14B, which are different from the above-mentioned state. By doing so, the optical path conversion element 153 of Embodiment 2 can convert an optical path selectively. Furthermore, for example, a photoreceptor also can be provided instead of the first and second output side optical fibers 36b and 36c so as to convert incident light to an electric signal selectively.

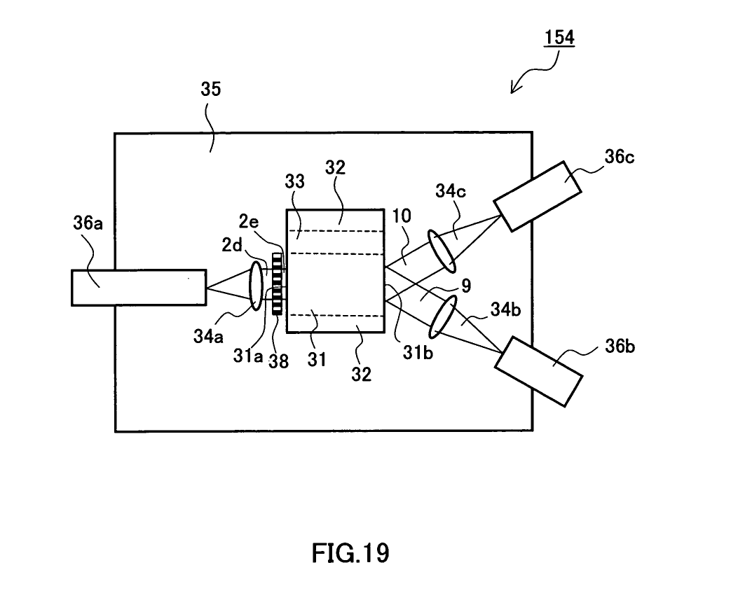

Furthermore, the optical path conversion element 153 shown in FIG. 18A has a configuration in which the incident light 2b is incident obliquely upon the incident end face 31a of the photonic crystal 31. For example, a phase grating can be placed between the incident side lens 34a and the incident end face 31a so that the incident light 2b is vertically incident upon the incident end face 31a of the photonic crystal 31. FIG. 19 is a plan view showing a configuration of a second optical path conversion element according to Embodiment 2. In the optical path conversion element 154 shown in FIG. 19, a phase grating 38 is placed between the incident side lens 34a and the incident end face 31a in the optical path conversion element 153 shown in FIG. 18A. Incident light 2d is vertically incident upon the incident end face 31a. The incident light 2d is converted to incident light 2e by the phase grating 38, and can perform propagation on the Brillouin zone boundary in the photonic crystal 31. More specifically, optical path conversion can be performed. Similarly, propagation light by a band on the Brillouin zone boundary may be generated in the photonic crystal 31, using the diffraction grating.

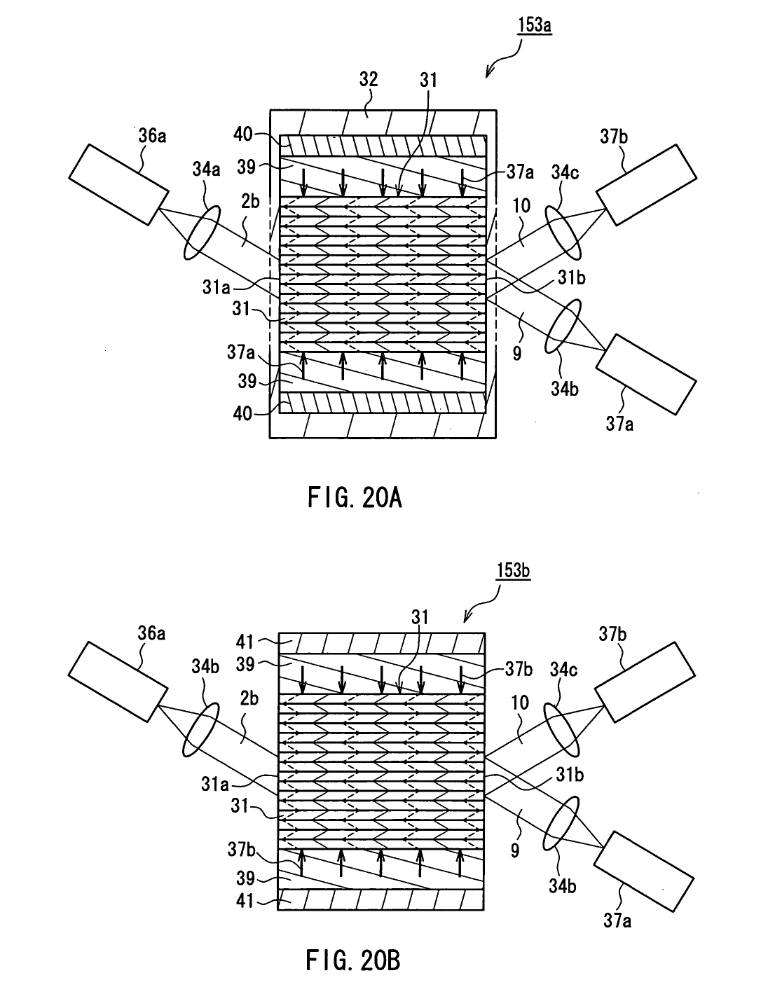

Hereinafter, the optical path conversion element according to Embodiment 2 with a configuration other than the above will be described. FIG. 20A is a cross-sectional view schematically illustrating the configuration of a third optical path conversion element according to Embodiment 2. As shown in FIG. 20A, in an optical path conversion element 153a, the photonic crystal 31 is sandwiched between two plate-shaped members 39 having rigidity. The plate-shaped members 39 are placed so as to be respectively in contact with surfaces perpendicular to the period direction of the photonic crystal 31. Extendable members 40 capable of controlling the thickness from the outside are placed in contact with surfaces of the plate-shaped member 39 opposing surfaces in contact with the photonic crystal 31. The support housing 32 is placed outside of the extendable members 40. An inner surface of the support housing 32 does not expand/contract in the period direction of the photonic crystal 31. As the extendable member 40, for example, a piston or the like of a hydraulic, pneumatic, or oil-pressure type may be used. By increasing the thickness of the extendable member 40, an external force 37a is applied to the photonic crystal 31, and the length in the period direction decreases. That is, by controlling the thickness of the extendable member 40, the length in the period direction of the photonic crystal 31 can be controlled. Because of this, by changing the photonic band structure of the photonic crystal 31, the direction of the output light of the photonic crystal 31 can be controlled. As the extendable member 40, the above-mentioned piezoelectric element may be used. Furthermore, although two extendable members 40 are used, one extendable member may be used as long as an external force can be applied to the photonic crystal 31.

Furthermore, an optical path conversion element 153b that applies an external force to the photonic crystal 31 with an electromagnet may be configured. FIG. 20B is a cross-sectional view schematically illustrating a configuration of a fourth optical path conversion element according to Embodiment 2. As shown in FIG. 20B, the photonic crystal 31 is sandwiched between the two plate-shape members 39 having rigidity. The plate-shaped members 39 are placed so as to be respectively in contact with surfaces perpendicular to the period direction of the photonic crystal 31. Electromagnets 41 are placed in contact with surfaces of the plate-shaped members 39 opposing surfaces in contact with the photonic crystal 31. A current is allowed to flow between the electromagnets 41 so as to generate an attracting force therebetween, whereby an external force 37a can be applied to the photonic crystal 31. The electromagnet 41 may be placed only on one side, and a magnetic substance such as iron may be placed on the other side.

As described above, the optical path conversion elements 153, 153a and 153b according to Embodiment 2 can be realized, which changes the period of the photonic crystal 31 to convert an optical path of output light from the photonic crystal 31 by applying an external force to the photonic crystal 31. The optical path conversion elements 153, 153a, and 153b can be miniaturized and integrated.

### Embodiment 3

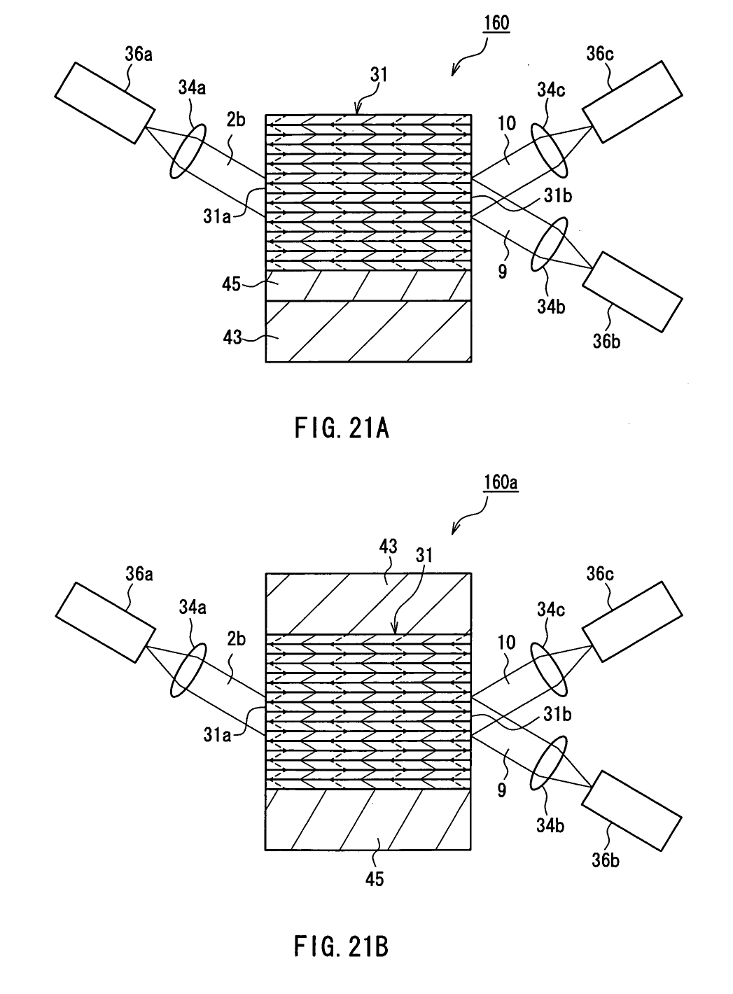

An optical path conversion element according to Embodiment 3 of the present invention will be described with reference to the drawings. The optical path conversion element of Embodiment 3 changes the period of a photonic crystal with heat, thereby changing a photonic band structure to convert an optical path of output light. FIG. 21A is a cross-sectional view schematically illustrating a configuration of the optical path conversion element according to Embodiment 3. As shown in FIG. 21A, the optical path conversion element 160 according to Embodiment 3 has a configuration in which a temperature varying device 43 that is a cooling device, a heating device, or the like is placed under a substrate 45 formed of a material having a high thermal expansion coefficient, and a one-dimensional photonic crystal 31 is placed on the substrate 45. The period direction of the photonic crystal 31 is a direction perpendicular to the surface of the substrate 45. On an incident end face 31a side of the photonic crystal 31, an incident side lens 34a and an incident side optical fiber 36a are placed, and on an exit end face 31b side, a first output side converging lens 34b and a first output side optical fiber 36b, and a second output side converging lens 34c and a second output side optical fiber 36c are placed. Incident light 2b having propagated in the incident side optical fiber 36a is incident upon the incident end face 31a through the incident side lens 34a.

By changing the temperature of the substrate 45 with the temperature varying device 43, the substrate 45 expands/contracts by thermal expansion. The photonic crystal 31 is formed on the substrate 45, and due to the influence of this configuration, the photonic crystal 31 is deformed and expands/contracts in the period direction. Therefore, the photonic band structure changes. As the temperature varying device 43, a heater, a Peltier element, or the like can be used. The setting position of the substrate 45 is not limited to the shown position, and the substrate 45 may be placed at the other positions as long as the photonic crystal 31 expands/contracts in the period direction due to the expansion/contraction of the substrate 45.

The operation of the optical path conversion element 160 of Embodiment 3 will be described. The incident light 2b having propagated in the incident side optical fiber 36a is incident upon the photonic crystal 31 through the incident side lens 34a. In the photonic crystal 31, propagation light by a band on a Brillouin zone boundary is propagating. By expanding/contracting the substrate 45 with the temperature varying device 43, the length in the period direction of the photonic crystal 31 is controlled, and the photonic band structure is changed. Because of this, the state of FIG. 14B or FIG. 14C is formed selectively. More specifically, the output light output from the exit end face 31b of the photonic crystal 31 can be switched selectively between 0th-order light 9 and 1st-order diffracted light 10. In the case where the output light is the 0th-order light 9, the 0th-order light 9 is converged by the first output side converging lens 34b, and combined with the first output side optical fiber 36b. Furthermore, in the case where the output light is the 1st-order diffracted light 10, the 1st-order diffracted light 10 is converged by the second output side converging lens 34c, and combined with the second output side optical fiber 36c.

Furthermore, at least one of the media constituting the photonic crystal 31 may be formed of a material having a high thermal expansion coefficient. FIG. 21B is a side view schematically illustrating a configuration of another optical path conversion element according to Embodiment 3. At least one of the media constituting the photonic crystal 31 is formed of a material having a high thermal expansion coefficient. As shown in FIG. 21B, the photonic crystal 31 is placed on the substrate 45, and the temperature varying device 43 is placed in the vicinity of or in contact with the photonic crystal 31. By heating or cooling the photonic crystal 31 with the temperature varying device 43, the photonic crystal 31 expands/contracts in the period direction. Consequently, the photonic band structure changes.

In the optical path converging elements 160 and 160a of Embodiment 3 shown in FIGS. 21A and 21B, the size in the period direction of the photonic crystal 31 can be changed directly with heat, without applying a mechanical external force to the photonic crystal 31. Because of this, in the same way as in the optical path conversion element of Embodiment 2, propagation light by a band on the Brillouin zone boundary is allowed to propagate through the photonic crystal 31, and a photonic band is changed, whereby the states of FIGS. 14B and 14C can be formed selectively. Consequently, an optical path conversion element can be realized, which can change the optical path of output light, and can be miniaturized and integrated.

### Embodiment 4

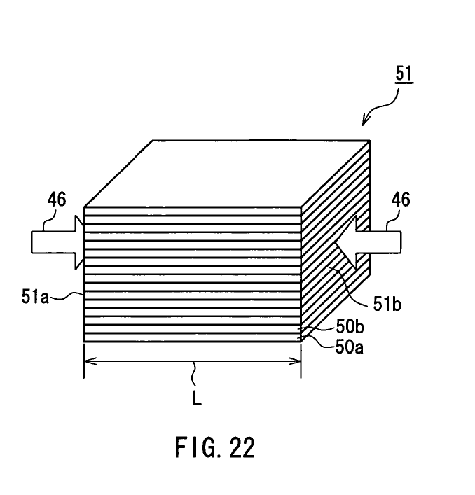

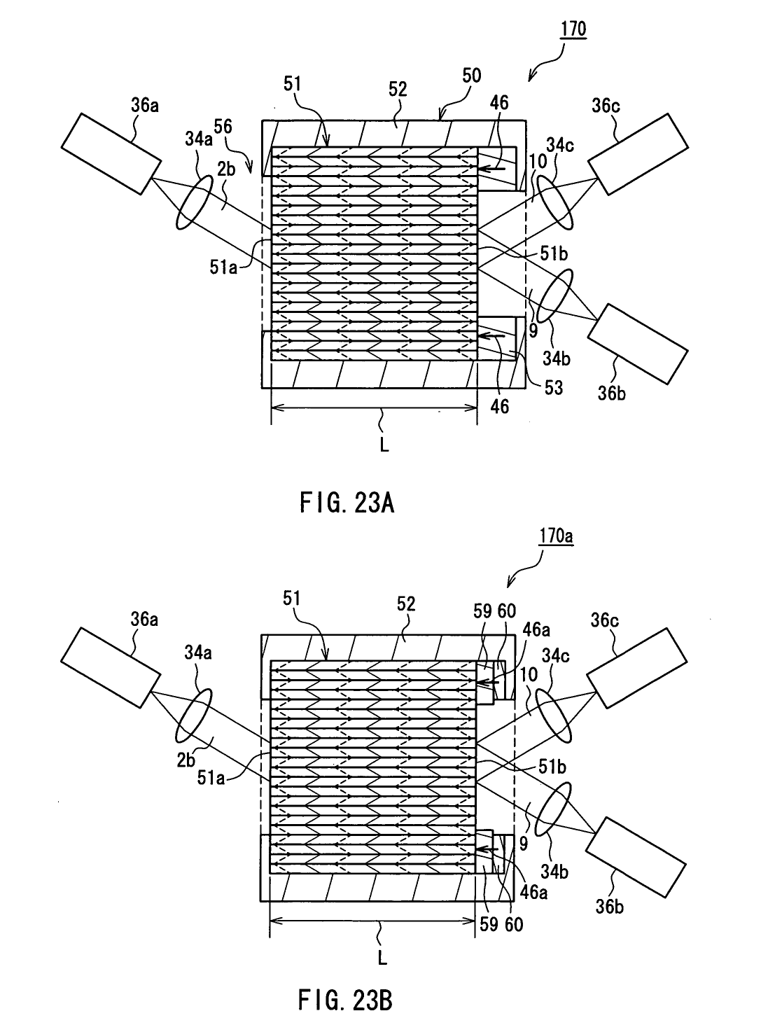

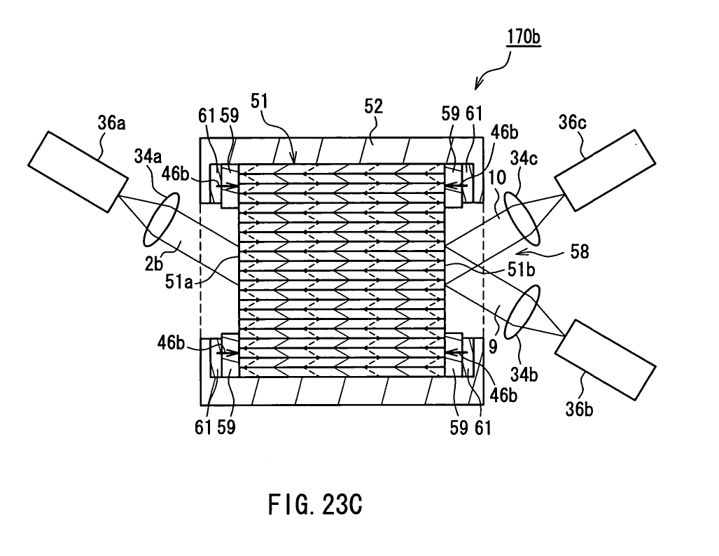

An optical path conversion element according to Embodiment 4 of the present invention will be described with reference to the drawings. FIG. 22 is a schematic view illustrating a method for changing the propagation optical path length of a photonic crystal. In FIG. 22, a one-dimensional photonic crystal 51 is configured in such a manner that materials 50a and 50b are layered alternately at a constant period. In the case of changing the length of a propagation optical path length L of the photonic crystal 51, an external force 46 may be applied in the propagation direction of propagation light. Because of this, the photonic crystal 51 can be deformed selectively between the state of FIG. 14B and the state of FIG. 14C. Consequently, the optical path of output light can be converted selectively FIG. 23A is a cross-sectional view schematically illustrating a configuration of the optical path conversion element according to Embodiment 4. As shown in FIG. 23A, an optical path conversion element 170 of Embodiment 4 includes an optical path conversion part 50, an incident side lens 34a, an incident side optical fiber 36a, a first output side converging lens 34b, a first output side optical fiber 36b, a second output side converging lens 34c, and a second output side optical fiber 36c.

The optical path conversion part 50 includes one-dimensional photonic crystal 51 having a periodic structure, a piezoelectric element 53 attached to a part of an exit end face 51b of the photonic crystal 51, and a support housing 52. The support housing 52 is connected to a surface of the piezoelectric element 53 opposing a surface in contact with the photonic crystal 51, and also is connected to a part of the incident end face 51a. An inside of the support housing 52 does not expand/contract in a propagation direction (propagation optical path length direction) of propagation light in the photonic crystal 51, which is parallel to each layer constituting the photonic crystal 51. That is, the length in the propagation optical path length direction of both the photonic crystal 51 and the piezoelectric element 53 is fixed. Herein, when a voltage is supplied to the piezoelectric element 53, the volume of the piezoelectric element 53 increases. Because of this, an external force 46 is applied to the photonic crystal 51 in the propagation optical path length direction. Consequently, the propagation optical path length L of the photonic crystal 51 becomes short. Thus, in the optical path conversion element 170 according to Embodiment 4, the propagation optical path length of the photonic crystal 51 can be changed. That is, the state of FIG. 14B or FIG. 14 can be formed selectively.

The reason why the piezoelectric element 53 is placed on a part of the exit end face 51b is to keep a portion where output light is output.

The operation of the optical path conversion element 170 of Embodiment 4 will be described. Incident light 2b having propagated in the incident side optical fiber 36a is incident upon the photonic crystal 51 through the incident side lens 34a. In the photonic crystal 51, propagation light by a band on a Brillouin zone boundary is propagating. By controlling a voltage supplied to the piezoelectric element 53, the propagation optical path length of the photonic crystal 51 can be controlled. Because of this, the state of FIG. 14B or FIG. 14C is formed selectively. That is, the output light output from the exit end face 51b of the photonic crystal 51 can be switched selectively between 0th-order light 9 and 1st-order diffracted light 10. In the case where the output light is the 0th-order light 9, the 0th-order light 9 is converged by the first output side converging lens 34b, and combined with the first output side optical fiber 36b. Furthermore, in the case where the output light is the 1st-order diffracted light 10, the 1st-order diffracted light 10 is converged by the second output side converging lens 34c, and combined with the second output side optical fiber 36c.

FIG. 23B is a cross-sectional view schematically illustrating a configuration of another optical path conversion element according to Embodiment 4. As shown in FIG. 23B, in an optical path conversion element 170a, a plate-shaped member 59 having rigidity is placed on a part of the exit end face 51b of the photonic crystal 51, and furthermore, an extendable member 60 capable of controlling the thickness of the photonic crystal 51 from the outside is placed in contact with the plate-shaped member 59. On an outer side of the extendable member 60, the support housing 52 is placed. An inner surface of the support housing 52 does not expand/contract in the propagation optical path length direction of the photonic crystal 51. As the extendable member 60, for example, a piston or the like of a hydraulic, pneumatic, or oil-pressure type may be used. By controlling the thickness of the extendable member 60, an external force 46a can be applied in the propagation optical path length direction of the photonic crystal 51. Thus, the propagation optical path length L of the photonic crystal 51 is allowed to expand/contract. Because of this, the direction of output light output from the exit end face 51b of the photonic crystal 51 can be controlled. As the extendable member 60, the above-mentioned piezoelectric element may be used. The reason why the plate-shaped member 59 is placed on a part of the exit end face 51b is to keep a portion where output light is output.

Furthermore, an optical path conversion element 170b that applies an external force to the photonic crystal 51 with an electromagnet may be configured. FIG. 23C is a cross-sectional view schematically illustrating a configuration of another optical path conversion element according to Embodiment 4. As shown in FIG. 23C, the photonic crystal 51 is sandwiched between two plate-shaped members 59 having rigidity. The plate-shaped members 59 are placed respectively in contact with the incident end face 51a and the exit end face 51b of the photonic crystal 51. An electromagnet 61 is placed in contact with a surface of each plate-shaped member 59 opposing a surface in contact with the photonic crystal 51. A current is allowed to flow to the electromagnets 61 so as to generate an attracting force therebetween, whereby an external force 46b can be applied to the photonic crystal 51. The electromagnet 61 may be placed only on one side of the incident end face 51a and the exit end face 51b, and a magnetic substance such as iron may be placed on the other side.

As described above, the optical path conversion elements 170, 170a and 170b according to Embodiment 4 can be realized, which change the propagation optical path length of the photonic crystal 51 to convert an optical path of output light from the photonic crystal 51 by applying an external force to the photonic crystal 51. The optical path conversion elements 170, 170a, and 170b can be miniaturized and integrated.

Even with the optical path conversion element 160 according to Embodiment 3 shown in FIG. 21A, an external force can be applied to the propagation optical path length direction of the photonic crystal 31 to control the length thereof. Such an optical path conversion element also can be used as an optical path conversion element that controls the propagation optical path length to convert an optical path of output light in the same way as in the optical path conversion element of Embodiment 4.

In the optical path conversion elements of Embodiments 2 to 4, light is incident obliquely upon the incident end face of a photonic crystal. However, light also can be vertically incident upon the incident end face by using a diffraction grating or a phase grating.

Hereinafter, results obtained by performing electromagnetic wave simulation (by a finite element method) regarding the above-mentioned optical path conversion elements will be shown. In all the following calculation examples, the length is normalized based on the period a of a photonic crystal. Calculation was conducted in a finite region.

### Calculation Example 1

Calculation Example 1 will be described, in the case where a plane wave was allowed to be incident upon an end face of a one-dimensional photonic crystal at an incident angel θ satisfying Expression (1). Calculation Example 1 will be described with reference to FIG. 6. Structure conditions of the photonic crystal 1 and conditions of the incident light 2 are as follows.

(1) Structure conditions of the photonic crystal 1

The photonic crystal 1 has a structure in which the materials 5a and 5b are layered alternately and periodically so as to obtain 12 periods

(Material 5a) Thickness t_{A}=0.5a Refractive index n_{A}=1.4578

(Material 5b) Thickness t_{B}=0.5a Refractive index n_{B}=1.00

The periphery of the photonic crystal 1 was set to be an air layer with a refractive index n of 1.0.

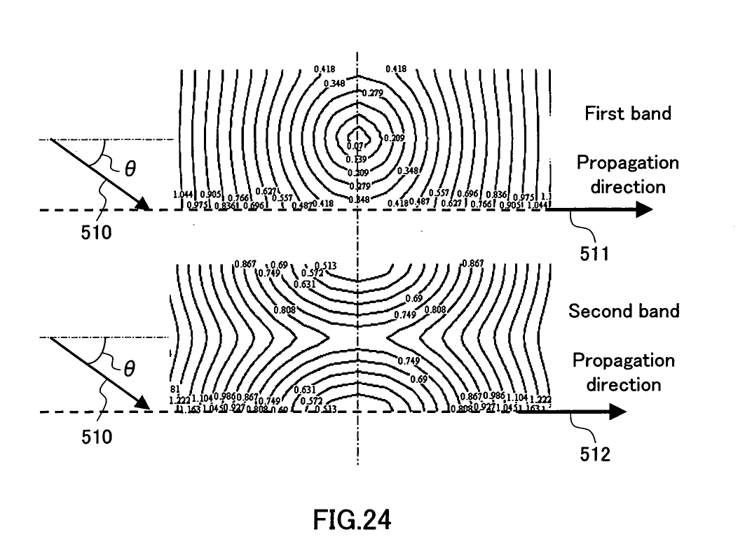

FIG. 24 is a band diagram of the photonic crystal 1 with respect to TE polarized light. In FIG. 24, an arrow 510 represents a wave vector of the incident light 2b, an arrow 511 represents an energy traveling direction of the propagation light 4a in the first band, and an arrow 512 represents an energy traveling direction of the propagation light 4b in the second band.

(2) Conditions of the incident light 2b

| | |
|---|---|
| (Wavelength in vacuum) | λ₀ = 0.9091a (a/λ₀ = 1.10) |
| (Polarized light) | TE polarized light (the direction of an |
| | electric field is an X-axis direction) |
| (Incident angle) | θ = 27.04° |

The conditions of the incident light 2b satisfy the condition of Expression (1).

FIG. 25 is an intensity distribution diagram of an electric field showing simulation results in Calculation Example 1. As is determined from the band diagram of FIG. 24, under the conditions of Calculation Example 1, propagation on a Brillouin zone boundary by the first and second bands occurs. Therefore, a characteristic propagation shape appears, in which two waves are overlapped with each other, and an electric field shape repeats a top peak and a bottom peak.

Furthermore, as a first reference example of Calculation Example 1, calculation also was conducted with respect to the case where the incident light 2b was allowed to be incident upon the photonic crystal 1 from two directions at an incident angle θ of ±27.04°. The other conditions were set to be the same as the above, and two lights were allowed to be incident so as to cross each other, and the position of an antinode of an interference wave was matched with the position of the high-refractive layer (material 5a). Calculation was conducted in a finite region, and the width of an incident portion of the incident light 2b at an incident end face was set to be about 13 periods.

FIG. 26 is an intensity distribution diagram of an electric field showing simulation results in a first reference example of Calculation Example 1. It is understood from FIG. 26 that, in the photonic crystal 1, only propagation light by the first band in which an electric field is localized in the high-refractive layer (material 5a) occurs.

Furthermore, as a second reference example of Calculation Example 1, calculation was conducted with respect to the case where the incident light 2b was allowed to be incident upon the photonic crystal 1 from two directions at an incident angle θ of ±27.04°, two light were allowed to be incident so as to cross each other, and the position of an antinode of an interference wave was matched with the position of the low-refractive layer (material 5b). The other conditions were set to be the same as those in the first reference example. FIG. 27 is an intensity distribution diagram of an electric field showing simulation results in a second reference example of Calculation Example 1. It is understood from FIG. 27 that, in the photonic crystal 1, only propagation light by the second band in which an electric field is localized in the low-refractive layer (material 5b) occurs.

### Calculation Example 2

Calculation Example 2 will be described, in the case where a plane wave was allowed to be incident upon an end face of a one-dimensional photonic crystal through a phase grating. Calculation Example 2 will be described with reference to FIG. 12. In Calculation Example 2, the phase grating 8 was placed on the incident end face 1a side of the photonic crystal 1, and the incident light 2d that was a plane wave was allowed to be vertically incident upon the phase grating 8.

(1) Structure conditions of the photonic crystal 1

The photonic crystal 1 has a structure in which the materials 5a and 5b are layered alternately and periodically.

(Material 5a) Thickness t_{A}=0.30 a Refractive index n_{A}=2.1011

(Material 5b) Thickness t_{B}=0.70 a Refractive index n_{B}=1.4578

FIG. 28 is a band diagram of the photonic crystal 1 with respect to TE polarized light. In FIG. 28, an arrow 610 represents a wave vector of the incident light, an arrow 611 represents an energy traveling direction of the propagation light in the first band, and an arrow 612 represents an energy traveling direction of the propagation light in the second band.

(2) Conditions of the incident light (plane wave 2d)

| | |
|---|---|
| (Wavelength in vacuum) | λ₀ = 1.321a (a/λ₀ = 0.7571) |
| (Polarized light) | TE polarized light (the direction of an |
| | electric field is an X-axis direction) |

(3) Structure of the phase grating 8

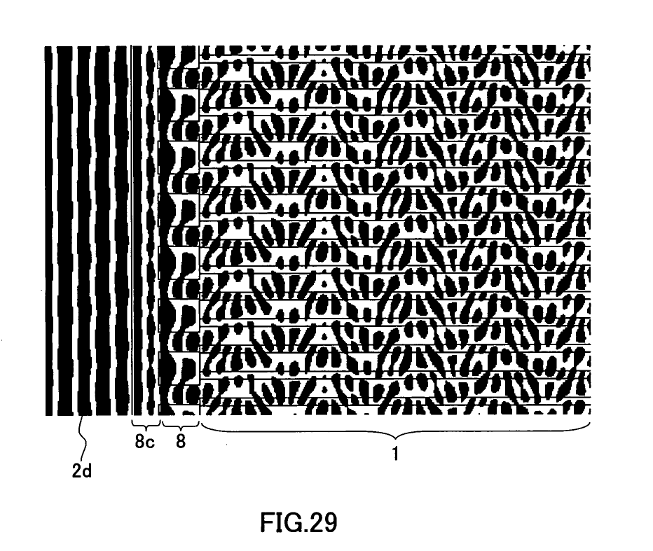

The phase grating 8 has a structure in which the materials 8a and 8b are layered alternately and periodically. The shape of the phase grating 8 was optimized so that ±1st-order diffracted light became strong.

| (Material 8a) | Thickness in the Y-axis direction t_{C} = | 0.7358a |
|---|---|---|
| | Refractive index n_{C} = | 1.45 |
| (Material 8b) | Thickness in the Y-axis direction t_{D} = | 1.2642a |
| | Refractive index n_{D} = | 1.00 |

| | |
|---|---|
| Period (t_{C} + t_{D}) of the phase grating 8 | 2a |
| The thickness t_{Z} in the Z-axis direction of the | 1.5094a |
| phase grating 8 | |
| Interval t_{E} (width of the layer 8c (see FIG. 29)) | 0.9434a |
| between the phase grating 8 and the air layer | |
| Refractive index between the phase grating 8 | 1.4578 |
| and the air layer | |

As described above, the shape of the phase grating 8 was optimized so that ±1st-order diffracted light became strong.

(4) Arrangement of the phase grating 8

The phase grating 8 was placed so as to be in contact with the incident end face 1a of the photonic crystal 1. Furthermore, the center of each layer (materials 8a and 8b) of the phase grating 8 is placed at a position shifted in the Y-direction by 0.2a from the center of the high-refractive layer (material 5a) of the photonic crystal 1. The incident light 2d is incident upon the phase grating 8 through the layer 8c from a free space with a refractive index of 1.00 (air).

FIG. 29 is an intensity distribution diagram of an electric field showing simulation results in Calculation Example 2. In Calculation Example 2, the high-refractive index layer (material 5a) and the low-refractive index layer (material 5b) are both placed in an antinode portion of a light wave in which the phase of the incident light 2d is modulated by setting the phase grating 8. It is understood from FIG. 29 that, because of the above configuration, the propagation light by the first band and the propagation light by the second band are generated, and a characteristic propagation shape appears in which these two waves are overlapped with each other, and the electric field shape repeats a top peak and a bottom peak.

### Calculation Example 3

Calculation Example 3 will be described, in the case where a plane wave was allowed to be incident upon a one-dimensional photonic crystal, in which a one-dimensional photonic crystal that was a confinement layer portion was placed on upper and lower surfaces of a one-dimensional photonic crystal that was a waveguide layer portion, at an incident angle θ satisfying Expression (1). As a calculation method, a time domain finite-difference method was used.

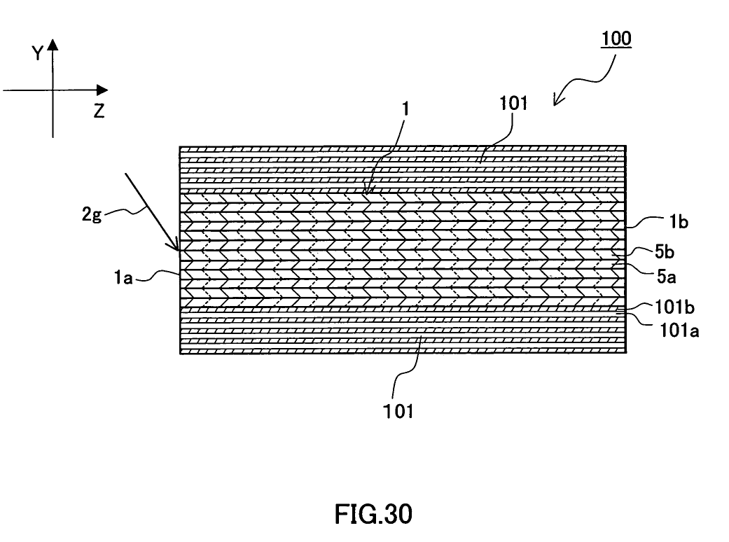

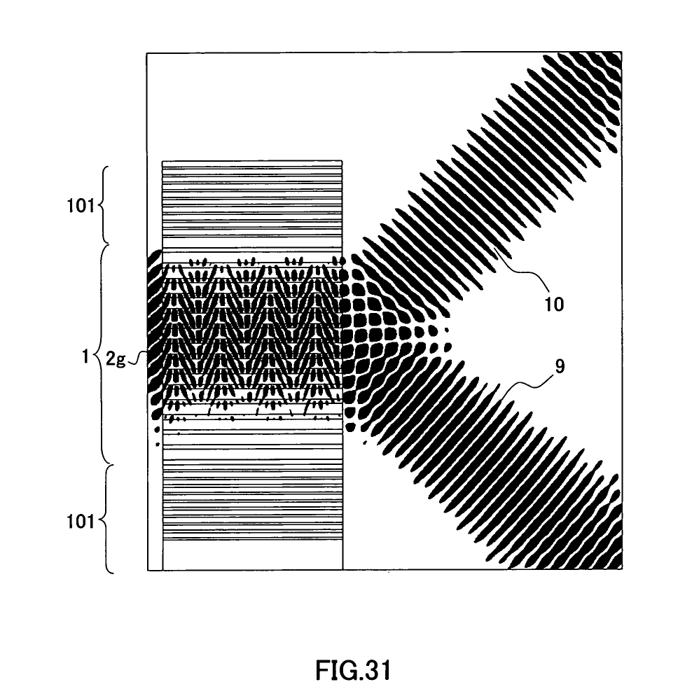

First, the structure of the photonic crystal used in Calculation Example 3 will be described. FIG. 30 is a cross-sectional view showing a configuration of the photonic crystal used in Calculation Example 3. As shown in FIG. 30, the photonic crystal 100 in Calculation Example 3 has a configuration in which the photonic crystal 101 that is a confinement layer portion is placed respectively on two surfaces perpendicular to the period direction of the photonic crystal 1 that is a waveguide layer portion. The period directions of these photonic crystals 1 and 101 are the same. Thus, the photonic crystal 101 that is a confinement layer portion is provided so as to sandwich the photonic crystal 1 that is a waveguide layer portion, so that light does not leak from the direction perpendicular to the period direction of the photonic crystal 1. Furthermore, the period direction of the photonic crystal 1 is the same as that of the photonic crystal 101, so that they can be produced easily. The structure conditions of each photonic crystal, and the conditions of the incident light 2g are as follows.

(1) Structure conditions of the photonic crystal 1 that is a waveguide layer portion

The photonic crystal 1 has a structure in which the materials 5a and 5b are layered alternately and periodically to obtain 15 periods (see FIG. 30).

(Material 5a) Thickness t_{A}=0.3a Refractive index n_{A}=2.1011

(Material 5b) Thickness t_{B}=0.7a Refractive index n_{B}=1.4578

(2) Structure conditions of the photonic crystal 101 that is a confinement layer portion

Each photonic crystal 101 has a structure in which materials 101a and 101b are layered alternately and periodically to obtain 10 periods. The thicknesses of the materials 101a and 101b are t_{G} and t_{H}, and the refractive indexes thereof are n_{G} and n_{H}.

(Material 101a) Thickness t_{G}=0.15a Refractive index n_{G}=2.1011

(Material 101b) Thickness t_{H}=0.35a Refractive index n_{H}=1.4578

The band diagram of the photonic crystal 1 is the same as that shown in FIG. 28.

It is assumed that a medium on an outer side of the photonic crystal 101 on an upper side (+direction of the Y-axis) has a refractive index of 1.00, and a medium on an outer side of the photonic crystal 101 on a lower side (−direction of the Y-axis) has a refractive index of 1.4578.

(3) Conditions of the incident light 2g

| | |
|---|---|
| (Wavelength in vacuum) | λ₀ = 1.4a (a/λ₀ = 0.7142) |
| (Polarized light) | TE polarized light (the direction of an |
| | electric field is an X-axis direction) |
| (Incident angle) | θ = 44.43° |

The conditions of the incident light 2g satisfy the condition of Expression (1).

The electric field shape in the photonic crystal 1 has a characteristic propagation shape that repeats a top peak and a bottom peak. Herein, simulation was performed by setting the length (propagation optical path length) in the Z-direction of a photonic crystal to be 1.1733a so that the exit end face 1b was placed in a bottom peak portion of the electric field. FIG. 31 is an intensity distribution diagram of an electric field showing simulation results in Calculation Example 3. The output light appears in two directions: the direction of 0th-order light 9 and the direction of 1st-order diffracted light 10.

### Calculation Example 4

Calculation Example 4 will be described, in the case where the photonic crystal in Calculation Example 3 was allowed to have a propagation optical path length so that an exit end face was placed at an intermediate position between the bottom peak and the top peak of the electric field shape of the propagation light.

The configurations of the photonic crystal 100 and the incident light 2g in Calculation Example 4 are the same as those of the photonic crystal in Calculation Example 3, but they are different from each other in a propagation optical path length. That is, it is assumed that the photonic crystal has a propagation optical path length so that the exit end face 1b is placed at an intermediate position between the bottom peak and the top peak of the electric field shape of the propagation light. Specifically, simulation was performed with the propagation optical path length of the photonic crystal 100 being 9.0666a. FIG. 32 is an intensity distribution diagram of an electric field showing simulation results in Calculation Example 4. It is understood from FIG. 32 that the output light does not propagate in the 1st-order diffraction direction, and propagates only in the direction of the 0th-order light 9.

### Calculation Example 5

Calculation Example 5 will be described, in the case where the photonic crystal in Calculation Example 3 was allowed to have a propagation optical path length so that the exit end face was placed at an intermediate position between the top peak and the bottom peak of the electric field shape of the propagation light.

The configurations of the photonic crystal 100 and the incident light 2g in Calculation Example 5 are the same as those of the photonic crystal in Calculation Example 3, but they are different from each other in a propagation optical path length. That is, it is assumed that the photonic crystal has a propagation optical path length so that the exit end face 1b is placed at an intermediate position between the top peak and the bottom peak of the electric field shape of the propagation light. Specifically, simulation was performed with the propagation optical path length of the photonic crystal 100 being 1.0666a. FIG. 33 is an intensity distribution diagram of an electric field showing simulation results in Calculation Example 5. It is understood from FIG. 33 that the output light does not propagate in the 0th-order light direction, and propagates only in the direction of the 1st-diffracted light 10.

### Calculation Example 6

Calculation was conducted with respect to the case where a plane wave was incident upon the incident end face 1a of the photonic crystal 1 with reference to FIG. 6.

(1) Structure conditions of the photonic crystal 1

The photonic crystal 1 has a structure in which the materials 5a and 5b are layered alternately and periodically so as to obtain 15 periods.

(Material 5a) Thickness t_{A}=0.30a Refractive index n_{A}=2.1011

(Material 5b) Thickness t_{B}=0.70a Refractive index n_{B}=1.4578

The band diagram of the photonic crystal 1 is the same as that in FIG. 28. It is assumed that a medium on an upper side (+direction of the Y-axis) of the photonic crystal 1 has a refractive index of 1.00, and a medium on a lower side (−direction of the Y-axis) has a refractive index of 1.4578.

(2) Conditions of the incident light 2b

| | |
|---|---|
| (Wavelength in vacuum) | λ₀ = 1.4286a (a/λ₀ = 0.7) |
| (Polarized light) | TE polarized light (the direction of an |
| | electric field is an X-axis direction) |
| (Incident angle) | θ = 45.58° |

The conditions of the incident light 2b satisfy the condition of Expression (1).

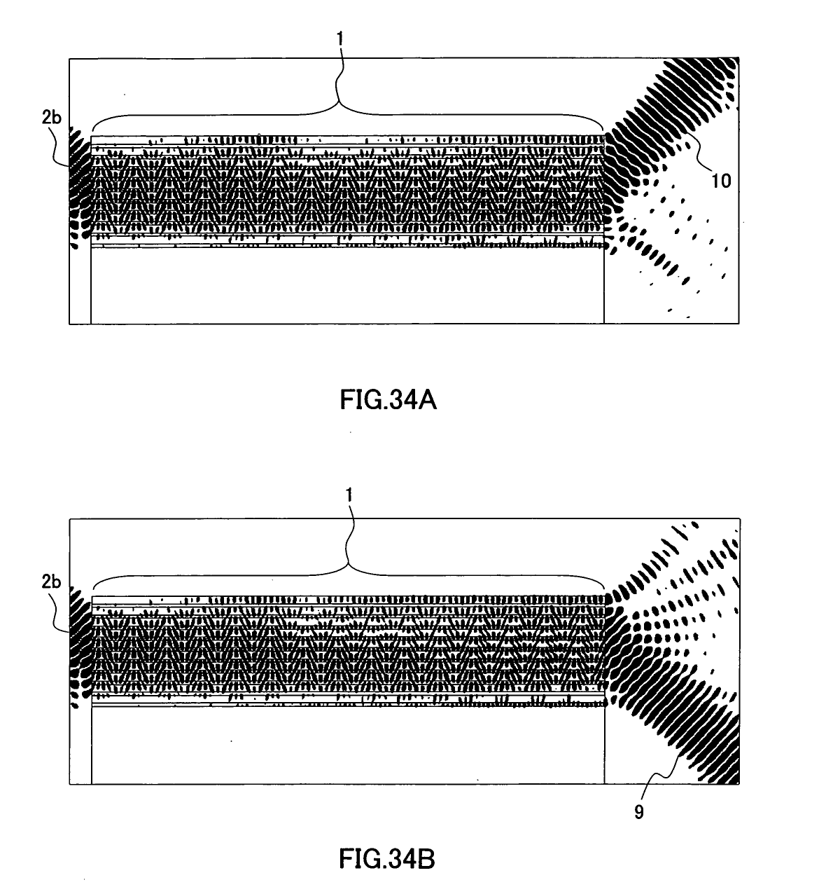

In the photonic crystal 1, a characteristic propagation shape appears, in which an electric field shape repeats a top peak and a bottom peak. Furthermore, the propagation optical path length of the photonic crystal 1 in which the output light was output to the direction of the 1st-order diffracted light 9 was obtained from a value of the period Λ(=(λz₁·λz₂)/(λz₂−λz₁)). Since the propagation optical path length was about 50 μm, calculation was conducted with the propagation optical path length of the photonic crystal 1 being 50 μm. FIG. 34A is an intensity distribution diagram of an electric field showing simulation results in Calculation Example 6. It can be confirmed from FIG. 34A that the output light is propagating in the direction of the 1st-order diffracted light 10.

### Calculation Example 7

Calculation Example 7 will be described, in the case where the refractive index of the high-refractive layer (material 5a) of the photonic crystal 1 in Calculation Example 6 increased by 1%.

(1) Structure conditions of the photonic crystal 1

The photonic crystal 1 has a structure in which the materials 5a and 5b are layered alternately and periodically to obtain 15 periods.

(Material 5a) Thickness t_{A}=0.30a Refractive index n_{A}=2.12211

(Material 5b) Thickness t_{B}=0.70a Refractive index n_{B}=1.4578

A medium on an upper side (+direction of the Y-axis) of the photonic crystal 1 has a refractive index of 1.00, and a medium on a lower side (−direction of the Y-axis) of the photonic crystal 1 has a refractive index of 1.4578.

(2) Conditions of the incident light 2b

| | |
|---|---|
| (Wavelength in vacuum) | λ₀ = 1.4286a (a/λ₀ = 0.7) |
| (Polarized light) | TE polarized light (the direction of an |
| | electric field is an X-axis direction) |
| (Incident angle) | θ = 45.58° |

The conditions of the incident light satisfy the condition of Expression (1).

The above conditions are the same as those in Calculation Example 6, with only the value of the refractive index n_{A} being different from the condition in Calculation Example 6.

FIG. 34B is an intensity distribution diagram of an electric field showing simulation results in Calculation Example 7. It can be confirmed from FIG. 34B that the output light is propagating in the direction of the 0th-order light 9.

When a normalized frequency a/λ₀ is 0.7 as in Calculation Examples 6 and 7, the change in the propagation vector kz due to a change in a refractive index is small. Therefore, when the length of the photonic crystal 1 is set to be about 50 μm, it is necessary that the change in a refractive index of at least one medium constituting the photonic crystal 1 is large. Specifically, the change in a refractive index of 1% is required (see Calculation Examples 6 and 7). However, if the value of a/λ₀ is smaller than this, the change in the propagation vector kz due to the change in a refractive index becomes large. Therefore, even with a small change in a refractive index, the required length of the photonic crystal 1 may be about several μm.

As described above, in the optical path conversion element of the present embodiment, by changing the photonic band structure or the propagation optical path length of a photonic crystal with respect to light having propagated in the photonic crystal using the first band and the high-order band (second band) on the Brillouin zone boundary, the direction of output light is converted. That is, by changing the period of the characteristic propagation shape generated by the overlapping of waves of the first or second band light in the photonic crystal, the direction of output light is converted. Alternatively, by changing the length (propagation optical path length) of the photonic crystal in the propagation direction, and changing the propagation shape of the propagation light at the exit end face, the direction of output light is converted. Thus, an optical path conversion element having a switching function can be realized.

The optical path conversion element according to the present embodiment can be miniaturized and integrated. Furthermore, the loss of propagation light is low.

### INDUSTRIAL APPLICABILITY

The optical path conversion element of the present invention can be used as a component such as an optical integrated circuit used in the field such as optical communication system, an optical exchange system, an optical interconnection, and the like.

1. An optical path conversion element, comprising:
a photonic crystal exhibiting periodicity of refractive index in one direction and using as an incident end face one of end faces substantially parallel with the periodicity direction of refractive index and an exit end face opposite the incident end face;
an incident part for passing an incident light through the incident end face such that a propagation light is generated in the photonic crystal by a band on a Brillouin zone boundary; and
a device for changing a photonic band structure of the photonic crystal and/or a device for changing a propagation optical path length that is a distance from the incident end face to the exit end face.

2. The optical path conversion element according to claim 1, wherein, assuming that a wavelength in vacuum of the incident light is λ₀, a refractive index of a medium that is in contact with the incident end face is n, and a period of the photonic crystal is a, the incident light is incident upon the incident part at an incident angle θ satisfying the following expression with respect to the incident end face:
0.45<n·sinθ·(a/λ₀)<0.55.

3. The optical path conversion element according to claim 2, wherein the incident part comprises a diffraction grating or a phase grating placed in a vicinity of or in contact with the incident end face.

4. The optical path conversion element according to claim 1, wherein the device for changing the photonic band structure supplies energy to the photonic crystal, thereby changing a refractive index of at least one of materials constituting the photonic crystal and changing the photonic band structure of the photonic crystal.

5. The optical path conversion element according to claim 4, wherein at least one of the materials constituting the photonic crystal is a material having an electro-optic effect, and
the device for changing the photonic band structure is an electric field applying part for applying an electric field to the photonic crystal.

6. The optical path conversion element according to claim 4, wherein at least one of the materials constituting the photonic crystal is a semiconducting material, and
the device for changing the photonic band structure is a current injecting part for injecting a current to the photonic crystal.

7. The optical path conversion element according to claim 4, wherein at least one of the materials constituting the photonic crystal is an acousto-optic material, and
the device for changing the photonic band structure is an ultrasonic wave applying part for applying an ultrasonic wave to the photonic crystal.

8. The optical path conversion element according to claim 4, wherein a part or an entirety of at least one of the materials constituting the photonic crystal is a non-linear optical material, and
the device for changing the photonic band structure is a light source for irradiating the photonic crystal with light.

9. The optical path conversion element according to claim 1, wherein the device for changing the photonic band structure is a period changing device for applying an external force to the photonic crystal to change a period of the photonic crystal, thereby changing the photonic band structure.

10. The optical path conversion element according to claim 9, wherein the period changing device comprises:
an external force applying part connected to at least one of end faces perpendicular to the periodicity direction of refractive index of the photonic crystal; and
a support housing for fixing a length in the periodicity direction of refractive index of the photonic crystal in the external force applying part and the photonic crystal,
wherein a volume of the external force applying part changes to apply the external force to the photonic crystal.

11. The optical path conversion element according to claim 10, wherein the external force applying part is a piezoelectric element.

12. The optical path conversion element according to claim 9, wherein the period changing device comprises a pair of electromagnets placed so as to oppose each other in the periodicity direction of refractive index of the photonic crystal with the photonic crystal interposed therebetween, and
the external force is applied to the photonic crystal, using an attracting force between the electromagnets.

13. The optical path conversion element according to claim 9, wherein the period changing device comprises an electromagnet and a magnetic substance placed so as to oppose each other in the periodicity direction of refractive index of the photonic crystal with the photonic crystal interposed therebetween, and
the external force is applied to the photonic crystal, using an attracting force between the electromagnet and the magnetic substance.

14. The optical path conversion element according to claim 9, wherein the period changing device comprises a substrate connected to the photonic crystal and a temperature varying device capable of heating or cooling the substrate, and
the external force is applied to the photonic crystal, using expansion or contraction of the substrate heated or cooled by the temperature varying device.

15. The optical path conversion element according to claim 1, wherein the device for changing the propagation optical path length comprises:
an external force applying part connected to at least one of the incident end face and the exit end face; and
a support housing for fixing a length in the direction of propagation optical path length of the photonic crystal in the external force applying part and the photonic crystal,
wherein a volume of the external force applying part changes to apply an external force to the photonic crystal.

16. The optical path conversion element according to claim 15, wherein the external force applying part is a piezoelectric element.

17. The optical path conversion element according to claim 1, wherein the device for changing the propagation optical path length comprises a pair of electromagnets placed so as to oppose each other in the direction of propagation optical path length of the photonic crystal with the photonic crystal interposed therebetween, and
an external force is applied to the photonic crystal, using an attracting force between the electromagnets.

18. The optical path conversion element according to claim 1, wherein the device for changing the propagation optical path length comprises an electromagnet and a magnetic substance placed so as to oppose each other in the direction of propagation optical path length of the photonic crystal with the photonic crystal interposed therebetween, and
an external force is applied to the photonic crystal, using an attracting force between the electromagnet and the magnetic substance.

19. The optical path conversion element according to claim 1, wherein the device for changing the propagation optical path length comprises a substrate connected to the photonic crystal and a temperature varying device capable of heating or cooling the substrate, and
an external force is applied to the photonic crystal, using expansion or contraction of the substrate heated or cooled by the temperature varying device.
